(19) United States
(12) Patent Application Publication
(10) Pub. No.: US 2007/0061720 A1
(43) Pub. Date: Mar. 15, 2007

(54) System, device, and method for conveying information using a rapid serial presentation technique

(76) Inventor: Joshua K. Kriger, Amherst, MA (US)

Correspondence Address: BROMBERG & SUNSTEIN LLP, 125 SUMMER STREET, BOSTON, MA, 02110-1618, US

(21) Appl. No.: 11/512,425

(22) Filed: Aug. 29, 2006

Related U.S. Application Data
(60) Provisional application No. 60/712,665, filed on Aug. 29, 2005.

(51) Int. Cl. G06F 3/00; G06F 17/00

(52) U.S. Cl. 715/700; 715/500.1

(57) ABSTRACT

An enhanced rapid serial presentation technique may utilize dictionaries and/or rule sets to improve the decisions that are made in generating targets and corresponding descriptors for a rapid serial presentation. Targets may include a single word, a group of words, audio components, video components, image components, and/or tactile components. Syntactic and/or semantic analysis of the content may be employed in order to account for the way in which words are used. The order in which information is presentation may take into account the context in which a particular consumer is accessing the information. Feedback information may be used to dynamically adjust the rendering of a presentation as well as to tailor presentations for a particular consumer. An authoring tool may be provided to enable user modification of a presentation. Advertisements may be included in a presentation.

### PRIORITY

The present application claims priority from U.S. Provisional Patent Application No. 60/712,665 entitled ENHANCED—RAPID SERIAL VISUAL PRESENTATION, which was filed on Aug. 29, 2005 in the name of Joshua K. Kriger, and which is hereby incorporated herein by reference in its entirety.

### FIELD OF THE INVENTION

The present invention relates generally to presentation of information using an enhanced rapid serial presentation technique.

### BACKGROUND OF THE INVENTION

In the early 20th century, the idea of a machine reader first emerged with the concept of a tachistoscope, for which the common definition is a device that projects words and images in rapid succession to test visual perception by increasing comprehension to aid in information intake and learning. Tachistoscopes are built using a cylinder having words and images viewed from the cylinder by a backlight, allowing projections to be processed visually.

When cognitive science started to gain recognition as a field of research during the 1970's, a parallel technique called rapid serial visual presentation emerged. Commonly referred to by the acronym RSVP, rapid serial visual presentation allows researchers to test many types of visual information processing by displaying a symbol, image, or word at a fixed location for a duration of time, followed by a successive symbol, image, or word.

Although RSVP technology has given scientists studying attention, memory, and learning an opportunity to gain insight into cognitive processes including attention, memory, and learning, RSVP has given the average person little if any direct benefit in their daily information intake. Some companies have tried to solve this problem by utilizing rapid serial visual presentation as a reading system to increase reading speed and comprehension, but despite much effort, have not resolved the fundamental issue of the uncomfortable feeling people often report when text is displayed using RSVP. Research in cognitive science has shown that using current RSVP techniques of text display, consumers still prefer normal methods of reading over RSVP.

U.S. Pat. No. 6,056,551 (Marasco, issued May 2, 2000), which is hereby incorporated herein by reference in its entirety, claims to offer methods to increase reading speed and user comprehension. Marasco understood the importance of using word groups to display text in rapid succession, but this technique is taught by almost all speed reading courses which emphasize reading in word grouping rather than refocusing on each word, thereby increasing reading time by requiring fewer eye movements (called saccades, which generally last 10-80 milliseconds, during which time no reading is effectively performed).

U.S. Pat. No. 4,845,645 (Matin, issued August 28, 1987), which is hereby incorporated herein by reference in its entirety, creates a display system and method to present data in real time rapid temporal succession at one spatial location. Envisioned for operators of nuclear power plants, military instruments, and air traffic controllers, no provisions were laid out to compensate for processing times for different modes of comprehension. Also claims were made for display times between 100 to 450 milliseconds; this parameter does not take into account language processing which can occur as fast as 40 milliseconds.

Several types of RSVP text display systems have been proposed and implemented, with products such as Acereader, Bailando, and BuddyBuzz providing various levels of functionality and sophistication. While some RSVP implementations merely display each word of text for a fixed amount of time and add delays at appropriate points (e.g., at a comma or at the end of a sentence), other RSVP implementations attempt to improve comfort levels for RSVP users by selecting the display characteristics for each word or phrase (e.g., display time, font, font size, font effect, color, etc.) based on such things :as the number of times a word has been encountered in the text (e.g., a word might be displayed for a longer amount of time the first time it is encountered, with subsequent instances of the word displayed for shorter amounts of time), word length (e.g., longer words may be displayed for longer amounts of time than shorter words), word frequency (e.g., a lexicon of word frequencies may be used to assign a weight to each word based on its measured frequency of use in textual content—see, for example, Oquist, Adaptive Rapid Serial Visual Presentation, 2001, which is hereby incorporated herein by reference in its entirety), and word type (e.g., proper names may be displayed for a longer amount of time than prepositions—see, for example, Kanellos, Reading phone text one word at a time, Jul. 13, 2005, which is hereby incorporated herein by reference in its entirety). Wong, Visible Language Workshop paper, which is hereby incorporated herein by reference in its entirety, discusses dynamic visual treatment of text as an extension of written language, and recognizes that a range of emotional qualities and tones of voice can be conveyed through treatment of the typographical form (e.g., typeface, weight, color) and also recognizes that electronic media extends the expressive possibilities by enabling typographic forms to change dynamically in size, color, and position according to a writer's expression or a reader's interaction in real time. Unfortunately, such implementations do not account for the way people actually process the words, and therefore generally do not provide substantial improvements in user comfort levels.

Other attempts to improve comfort levels for RSVP users involve various types of interfaces through which the user can control rendering of the presentation, such as the overall rate of textual display (e.g., speed up or slow down) and the ability to pause and rewind the display (see, for example, Williams, RSVP User's Guide, 1999, which is hereby incorporated herein by reference in its entirety). Some proposals incorporate a “familiar metaphor” for controlling the RSVP display, such as through controls that mimic driving an automobile or flying an airplane (see, for example, U.S. Pat. No. 6,515,690 issued on Feb. 4, 2003 to Back et al.; Back et al., The AirBook: force-free interaction with dynamic text in an assistive reading device; and Back et al., Speeder Reader: An Experiment in the Future of Reading, all of which are hereby incorporated herein by reference in their entireties. Still other proposals involve monitoring eye movements and automatically adjusting the RSVP display, e.g., slowing down the display if the user looks away from the screen (see, for example, Akervall, Smart Bailando Eye controlled RSVP on handhelds, 2002, which is hereby incorporated herein by reference in its entirety). In general, such attempts to improve comfort levels have not met with much success because they are either difficult for the user or are impractical (e.g., the eye monitoring proposal requires two cameras, which is not practical on a small portable consumer device; similarly, input devices that mimic driving or flying are not practical for use with small portable consumer devices).

Recently, there has been a particular focus on RSVP implementations intended for consumer devices having small display screens, such as, for example, mobile telephones, personal digital assistants, personal computers, pagers, video games, wrist watches, and the like, particularly because such devices are generally not well-suited for textual display (see, for example, Muter, Interface Design and Optirization of Reading of Continuous Text, 1996; Goldstein et al., Enhancing the Reading Experience: Using Adaptive and Sonified RSVP for Reading on Small Displays; Castelhano et al., Optimizing the reading of electronic text using rapid serial visual presentation (2001); Sicheritz, Applying the Rapid Serial Visual Presentation Technique to Small Screens; Chittaro, Visualizing Information on Mobile Devices, March 2006; Johnson, Opus: Composing and Exploring Dynamic Typography; and U.S. Published Patent Application Ser. No. 2006/0100984 to Fogg et al., all of which are hereby incorporated herein by reference in their entireties). Furthermore, there has also been a focus on the use of RSVP for navigating applications on consumer devices, such as, for example, scrolling through the various menus of a cell phone, PDA, or web browser (see, for example, de Bruijn et al., RSVP Browser-Web Browsing on Small Screen Devices, which is hereby incorporated herein by reference in its entirety, and de Bruijn et al., Rapid Serial Visual Presentation, which is hereby incorporated herein by reference in its entirety). Here, rather than requiring the user to scroll through a list of menu options (e.g., using a mouse or scroll wheel), icons representing the various options may be displayed to the user sequentially, and the user can select an option, for example, by “clicking” when the corresponding icon is being displayed.

In the context of RSVP for use with portable consumer devices, certain proposed systems include a backend server that converts textual content into a markup language file and sends the markup language file to the consumer device for rendering (see, for example, Oquist, Adaptive Rapid Serial Visual Presentation, 2001, which was incorporated by reference above, and U.S. Published Patent Application Ser. No. 2006/0100984 to Fogg et al., which was incorporated by reference above).

Thus, even though the underlying RSVP concepts have been around for decades and there have been a number of recent attempts to improve RSVP, RSVP implementations remain woefully inadequate for mass consumption of information.

### SUMMARY OF THE INVENTION

In accordance with one aspect of the invention there is provided a method conveying electronic information content to a consumer using a rapid serial presentation technique. The content is characterized by a sequence of terms. The method involves maintaining a plurality of rule sets, each of the rule sets defining rules for generating targets and descriptors for a rapid serial presentation of the terms based at least in part on attributes of the terms, each rule set customized for at least one of a particular consumer and a particular type of content; selecting a rule set, from among the plurality of rule sets, based on at least one of a consumer specification and the type of content; accessing a dictionary to obtain quantified attributes associated with at least some of the terms; and generating a sequence of targets and corresponding descriptors for the rapid serial presentation of the terms using the selected rule set and the quantified attributes obtained from the dictionary. The descriptors define characteristics for outputting the targets during a rendering of the rapid serial presentation.

In various alternative embodiments, targets may include a single term, a group of terms, an audio component, a video component, an image component, and/or a tactile component. The attributes obtained from the dictionary may include psycholinguistic attributes. The dictionary may be selected from among a plurality of dictionaries, for example, based on a consumer selection or the type of content.

The type of content for selecting a dictionary and/or a rule set may be determined using a search term provided by the consumer or an analysis of the content. A consumer selection for selecting a dictionary and/or a rule set may be provided in a consumer profile or as an input from the consumer.

The sequence of targets and corresponding descriptors may be generated by analyzing the content for at least one of syntax and semantics and generating the sequence of targets and corresponding descriptors based at least in part on such analysis. Alternatively, or additionally, the sequence of targets and corresponding descriptors may be generated based at least in part on a consumer profile, which may include preference information provided by the consumer and/or feedback information characterizing consumer experience with rapid serial presentations. Such feedback information may include information relating to a latent physiological condition of the consumer monitored during rendering of the rapid serial presentation and/or information relating to consumer inputs during rendering of the rapid serial presentation.

After generation of the sequence of targets and corresponding descriptors, an authoring tool may be provided to enable a user to modify the sequence of targets and corresponding descriptors. Such modification may include such things as converting multiple targets into a single target, converting a single target into multiple separate targets, defining characteristics for outputting a target, inserting an additional target, and removing a target.

One or more advertisements may be included at the beginning of the rapid serial presentation. The number of advertisements may be selected according to a price to be charged to the consumer for the rapid serial presentation.

Generation of the targets and corresponding descriptors may take into account the context within which the consumer is accessing the content such that portions of the content may be presented in a different order based on the context. To this end, generation of the targets and corresponding descriptors may involve determining the order in which different portions of content are to be delivered to the consumer based on a context for the rapid serial presentation and generating the targets and corresponding descriptors based at least in part on the determined order and the context.

In accordance with another aspect of the invention there is provided a method of conveying electronic information content to a consumer using a rapid serial presentation technique. The content is characterized by a sequence of terms. The method involves accessing a dictionary to obtain psycholinguistic attributes associated with at least some of the terms and generating a sequence of targets and corresponding descriptors for a rapid serial presentation of the terms using the associated psycholinguistic attributes. The descriptors define characteristics for outputting the targets during a rendering of the rapid serial presentation.

In accordance with another aspect of the invention there is provided a method of conveying electronic information content to a consumer using a rapid serial presentation technique. The content is characterized by a sequence of terms. The method involves maintaining a plurality of rule sets, each of the rule sets defining rules for generating targets and descriptors for a rapid serial presentation of the terms, each rule set customized for at least one of a particular consumer and a particular type of content; selecting a rule set, from among the plurality of rule sets, based on at least one of a consumer specification and the type of content; and generating a sequence of targets and corresponding descriptors for the rapid serial presentation of the terms using the selected rule set. The descriptors define characteristics for outputting the targets during a rendering of the rapid serial presentation.

In accordance with another aspect of the invention there is provided apparatus for generating a rapid serial presentation of electronic information content. The content is characterized by a sequence of terms. The apparatus includes a network interface for enabling communication over a communications network; a database for storing a plurality of rule sets, each of the rule sets defining rules for generating targets and descriptors for a rapid serial presentation of the terms based at least in part on attributes of the terms, each rule set customized for at least one of a particular consumer and a particular type of content; a presentation generator, in communication with the database and with the network interface, for generating the rapid serial presentation, the presentation generator configured to select a rule set, from among the plurality of rule sets, based on at least one of a consumer specification and the type of content; access a dictionary to obtain quantified attributes associated with at least some of the terms; and generate a sequence of targets and corresponding descriptors for the rapid serial presentation of the terms using the selected rule set and the quantified attributes obtained from the dictionary. The descriptors define characteristics for outputting the targets during a rendering of the rapid serial presentation.

The dictionary may be stored in the database or may be accessed over the communications network via the network interface. Each target may include targets may include a single term, a group of terms, an audio component, a video component, an image component, and/or a tactile component. The dictionary may include psycholinguistic attributes for at least some of the terms. The presentation generator may be configured to select the dictionary from among a plurality of dictionaries based on at least one of a consumer selection and the type of content, wherein each of the dictionaries is customized for at least one of a particular consumer and a particular type of content. The presentation generator may be configured to analyze the content for at least one of syntax and semantics and to generate the sequence of targets and corresponding descriptors based at least in part on such analysis. The presentation generator may be configured to generate the sequence of targets and corresponding descriptors based at least in part on a consumer profile, the consumer profile including at least one of preference information provided by the consumer and feedback information characterizing consumer experience with rapid serial presentations. The consumer profile may be stored in the database.

The apparatus may further include a web server, in communication with the database, the network interface, and the presentation generator, for at least one of obtaining content via the network interface, transmitting the rapid serial presentation to a consumer device via the network interface, and configuring the presentation generator.

The apparatus may additionally or alternatively include an authoring tool for enabling a user to modify the sequence of targets and corresponding descriptors. Such modification may include converting multiple targets into a single target, converting a single target into multiple separate targets, defining characteristics for outputting a target, inserting an additional target, and removing a target.

In accordance with another aspect of the invention there is provided a method of rendering a rapid serial presentation to a consumer. The rapid serial presentation includes a sequence of targets and corresponding descriptors. the method involves outputting targets on a consumer device in accordance with the corresponding descriptors; concurrently with such outputting, monitoring a latent physiological condition of the consumer; analyzing the latent physiological condition to infer an emotional state of the consumer with regard to the rapid serial presentation; and dynamically adjusting the outputting of subsequent targets based on the inferred emotional state of the consumer.

The latent physiological condition may include such things as heart rate, blood flow, brain waves, electronic signals, galvanic skin response, breathing, and temperature. Feedback information relating to the latent physiological condition may be transmitted to a presentation server for use in generating a subsequent rapid serial presentation for the consumer. In accordance with another aspect of the invention there is provided apparatus for rendering a rapid serial presentation to a consumer. The rapid serial presentation includes a sequence of targets and corresponding descriptors. The apparatus includes a network interface for enabling communication over a communications network and over which the rapid serial presentation is received; at least one output; a physiological sensor; and a presentation player, in communication with the network interface, the at least one output, and the physiological sensor, the presentation player configured to output targets using the at least one output in accordance with the corresponding descriptors; concurrently monitor a latent physiological condition of the consumer using the physiological sensor; analyze the latent physiological condition to infer an emotional state of the consumer with regard to the rapid serial presentation; and dynamically adjust the outputting of subsequent targets based on the inferred emotional state of the consumer.

The at least one output comprises may include such things as a display screen, an audio output, and a tactile output. The latent physiological condition may include such things as heart rate, blood flow, brain waves, electronic signals, galvanic skin response, breathing, and temperature. The presentation player may be configured to transmit via the network interface feedback information relating to the latent physiological condition to a presentation server for use in generating a subsequent rapid serial presentation for the consumer. The apparatus may further include a web browser, in communication with the network interface and the presentation player. The presentation player may be integrated with the web browser. The apparatus may further include at least one input, in communication with the presentation player, through which the consumer can manually control various aspects of the outputting of the targets.

In accordance with another aspect of the invention there is provided a rapid serial presentation system comprising a server for generating a rapid serial presentation for a consumer and a consumer device, in communication with the server, for rendering the rapid serial presentation to the consumer, wherein the consumer device is configured to transmit feedback information to the server, the feedback information characterizing the consumer experience with the rapid serial presentation, and wherein the server is configured to use the feedback information in generating a subsequent rapid serial presentation for the consumer.

In accordance with another aspect of the invention there is provided a method of presenting electronic information content to a consumer using a rapid serial presentation technique. The method involves recording a reading of the content; analyzing the recorded reading to identify verbal characteristics; parsing the content into a sequence of terms; and generate a sequence of targets and corresponding descriptors using the verbal characteristics, so that a rapid serial visual presentation of the targets will mimic at least in part the verbal characteristics.

In accordance with another aspect of the invention there is provided a method in which the consumer may be charged a different amount for access to content based on the number of advertisements that the consumer is willing to view. Such a method may be applied to online content in general and is not limited to use with rapid serial presentations. Thus, for example, such a method may be used in conjunction with electronic books, newspaper articles, etc.

It should be noted that the present invention is not limited to the above-described aspects.

### BRIEF DESCRIPTION OF THE DRAWINGS

The foregoing and advantages of the invention will be appreciated more fully from the following further description thereof with reference to the accompanying drawings wherein:

FIG. 1 is a conceptual diagram depicting a RSP system in accordance with an exemplary embodiment of the present invention;

FIG. 2 is a schematic block diagram showing the relevant components of an RSP server in accordance with an exemplary embodiment of the present invention;

FIG. 3 is a schematic block diagram showing the relevant components of an RSP generator in accordance with an exemplary embodiment of the present invention;

FIG. 4 is a schematic block diagram showing possible contents of a database in accordance with an exemplary embodiment of the present invention;

FIG. 5 is a schematic block diagram showing the relevant components of consumer device in accordance with an exemplary embodiment of the present invention;

FIG. 6 is a logic flow diagram for generating targets and corresponding descriptors in accordance with exemplary embodiments of the present invention;

FIG. 7 is a logic flow diagram for use of a dictionary containing psycholinguistic attributes, in accordance with an exemplary embodiment of the present invention;

FIG. 8 is a logic flow diagram for use of rule sets, in accordance with an exemplary embodiment of the present invention;

FIG. 9 is a logic flow diagram for text-to-speech in accordance with an exemplary embodiment of the present invention; and

FIG. 10 is a logic flow diagram for biofeedback in accordance with an exemplary embodiment of the present invention.

### DETAILED DESCRIPTION OF SPECIFIC EMBODIMENTS

Definitions

As used in this description and the accompanying claims, the following terms shall have the meanings indicated, unless the context otherwise requires:

“Content” is electronic information to be presented to a consumer. Content can include such things as stored information files, streamed information, web pages, electronic books, and the like. An online database, such as wikipedia, can represent content.

A “term” is a quantum of information, such as a word or phrase, that is parsed from content. In essence, content can be characterized as a sequence of terms.

A “target” is information to be presented as a unit to a consumer as part of a rapid serial presentation. Targets are generally derived from content and can include, for example, a single term or a group of terms. Additional targets, such as, for example, inserted text, audio, video, image, and tactile information, can also be included in a rapid serial presentation.

A “descriptor” defines one or more characteristics for presenting a target during a rapid serial presentation. Descriptors can define any of a number of typographic and display attributes, such as font, font size, font style/effects (e.g., bold, underline, italic), font color, display position, display orientation, display duration, and the like. A descriptor may define different characteristics for different parts of the target, e.g., first word bold, second word green, third word in different font. Descriptors may be in the form of XML-like tags.

“Rapid serial presentation” or “RSP” is an expansion of Rapid Serial Visual Presentation (RSVP) that includes enhanced textual display capabilities and may also incorporate audio, visual, and tactile components.

The term “rapid serial presentation” may be used to refer to a compilation of a sequence of targets and corresponding descriptors that is capable of being rendered on a consumer device. A rapid serial presentation generally, although not necessarily, includes at least one descriptor for each target. A rapid serial presentation may include multiple descriptors for a single target and may include independent descriptors that are not associated with any particular target. A rapid serial presentation may be in the form of a markup language file (e.g., using XML-like syntax) or other electronic document.

The term “rapid serial presentation” may also be used to refer to the actual rendering of the compilation on a consumer device.

A “consumer device” is a device capable of rendering a rapid serial presentation. A consumer device typically includes at least a display screen (e.g., a CRT, LCD, plasma screen) on which visual information (e.g., textual, video, image information) can be displayed, but may also include other components, such an audio output (e.g., a speaker or buzzer) for generating audible signals or a tactile output (e.g., a vibrator or a movable member, for example, as in U.S. Pat. No. 5,989,099, which is hereby incorporated herein by reference in its entirety) for generating tactile signals. Consumer devices may be stationary or mobile. Some examples of mobile consumer devices include mobile telephones, personal digital assistants, personal computers, pagers, video games, digital watches, and the like. Some examples of stationary consumer devices include desktop computers, television monitors, kiosks, automated teller machines, and the like. A consumer device is not required to support rendering of all types of targets and descriptors. For example, a consumer device without a tactile output might ignore targets/descriptors that convey tactile signals.

A rapid serial presentation is “rendered” on a consumer device by serially outputting the sequence of targets on the consumer device in accordance with the presentation characteristics specified by the descriptors. During rendering of a rapid serial presentation, textual information is generally displayed at a single predetermined location on a display screen, although the descriptors may specify a different orientation, position, or other display attribute for certain textual information.

A “dictionary” is a database of information characterizing at least some of the terms. Each term in the dictionary may be associated with various attributes, including linguistic and psycholinguistic attributes. Each attribute is typically assigned a quantitative value. Exemplary dictionaries include the Medical Research Council (MRC) Psycholinguistic Database and the Oxford Psycholinguistic Database, which define 26 linguistic and psycholinguistic attributes by which terms can be characterized. The various attributes are described in Wilson, MRC Psycholinguistic Database: Machine Usable Dictionary. Version 2.00, Oxford University Computing Service, 1987, which can be found at http://www.psy.uwa.edu.au/mrcdatabase/mrc2.html (referred to hereinafter as the “MRC2 Dictionary Documentation”), the content of which is attached hereto as Appendix A and is hereby incorporated herein by reference in its entirety. “Lingustic attributes” include such things as number of letters in the word, number of phonemes in the word, number of syllables in the word, Kucera and Francis written frequency, Kucera and Francis number of categories, Kucera and Francis number of samples, Thorndike-Lorge frequency, Brown verbal frequency, type, part of speech (SOED syntactic category), part of speech Jones' Pronouncing Dictionary syntactic category), alphasyllable, status, variant phoneme, written capitalized, irregular plural, the actual word, phonetic transcription, edited phonetic transcription, and stress pattern; “psycholinguistic attributes” include such things as familiarity, concreteness, imagery, mean Colerado meaningfulness, mean Pavio meaningfulness, and age of acquisition. Descriptions of these linguistic and psycholinguistic attributes can be found In the MRC2 Dictionary Documentation. It should be noted that the dictionary need not (and typically does not) include a quantified value for each attribute for each term. A particular RSP implementation may support multiple dictionaries that are configured for specific uses, such as for different types of content or different users. Custom dictionaries may be created specifically for RSP, with new or modified types of psycholinguistic attributes reflecting users' experiences with RSP. A dictionary may include entries defining interactions between words, phrases, sounds, images, and tactile signals. A dictionary may include one or more default entries for use when a term is not in the dictionary or a referenced attribute for a particular term is not quantified.

A “rule set” is a set of rules for converting terms into a sequence of targets and related descriptors. There may be different rule sets for different users and/or different types of content.

A “latent physiological condition” is a physiological condition of a consumer that is not outwardly apparent but is capable of being monitored and quantified in order to infer an emotional state of the consumer during a rapid serial presentation. Physiological parameters may include such things as heart rate, blood flow, brain waves, electronic signals, galvanic skin response, breathing, temperature, and other latent physiological conditions, but would not include such things as eye movements and blinking that can be outwardly observed.

### Introduction

Embodiments of the present invention provide a number of enhancements over traditional Rapid Serial Visual Presentation (RSVP) techniques and implementations. For example, conversion of content into targets and descriptors may utilize psycholinguistic information in order to account for the way in which people process certain terms. Rule sets may be employed to process content differently for different users or for different types of content. User profiles may be used to tailor a rapid serial presentation to a particular user or group of users. Techniques are discussed for creating a rapid serial presentation that mimics a reading of textual content. Techniques are also discussed for dynamically adjusting the rendering of a rapid serial presentation based on latent physiological conditions that infer an emotional state of the user. Information about the user (such as latent physiological conditions and other metrics) may be collected by the consumer device and transmitted to a central server so that user preferences can be tracked and used during the creation of subsequent rapid serial presentations for the user. These and other enhancements are discussed further below.

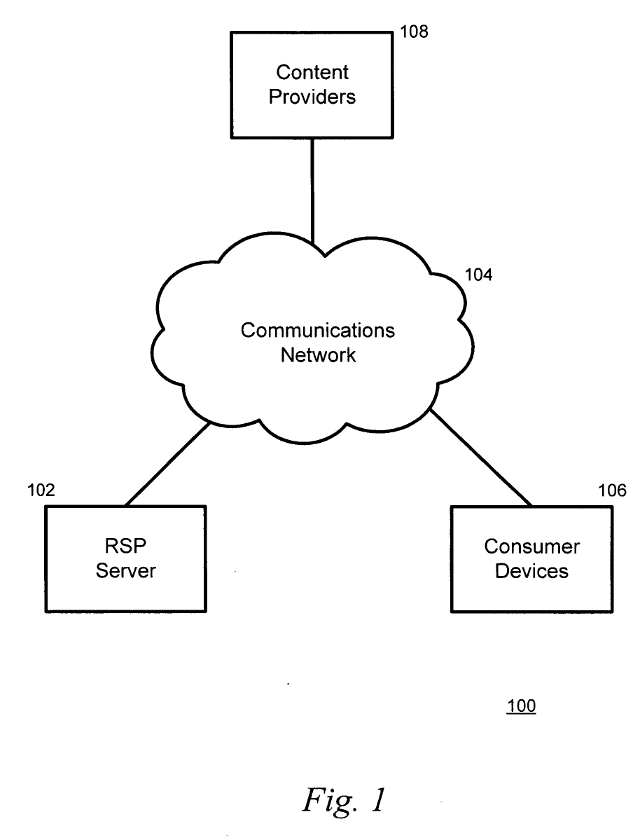

FIG. 1 is a conceptual diagram depicting a RSP system 100 in accordance with an exemplary embodiment of the present invention. In this example, A RSP Server 102 is in communication with various consumer devices 106 and various content providers 108 over a communications network 104. The RSP server 102 typically obtains content from the content servers 108, for example, by downloading content from the content providers 108 at various times and/or receiving content streams from the content providers 108. The RSP server 104 generates rapid serial presentations, for example, in the form of XML-like files. The RSP server 104 may generate a particular rapid serial presentation in real time (e.g., as streamed content is received) or may generate a rapid serial presentation on demand (e.g., upon receiving a request for specified information from a consumer device 108). The RSP server 104 may store rapid serial presentations locally and/or may transmit rapid serial presentations over the communications network 104 to the various consumer devices 106. The consumer devices 108 render the rapid serial presentations under user control or otherwise in due course.

It should be noted that the communications network 104 is not intended to represent any particular network, but rather is intended to represent any one or more communications networks by which, or through which, the various devices communicate. The communications network 104 need not be a single contiguous network, but rather may include multiple distinct networks. Thus, the communications network 104 may include public and/or private networks, including the Internet, and may include wireless (e.g., cellular telephone, Blackberry, Bluetooth, satellite) or wired (e.g., PSTN, cable modem, DSL) networks capable of conveying information to and from communication devices.

During operation of the RSP system 100, a consumer device 106 may send a request for specified content to the RSP server 102. For example, the consumer device 106 may request a particular document, web page, or search term for a database lookup. Provided the specified content is not stored locally at the RSP server 102, the RSP server 102 interacts with the appropriate content provider 108 in order to obtain the specified content. Upon receipt of the specified content from the appropriate content provider 108, the RSP server 102 processes the content and generates an appropriate rapid serial presentation, which is then transmitted to the requesting consumer device 108. The rapid serial presentation is then available to be rendered to the user.

In one exemplary embodiment, the RSP server 102 will maintain a local copy of a remote database. Specifically, the RSP server 102 will periodically copy information from the remote database to the local copy in order to remain some degree of synchronization with the remote database. Accesses to the database made by the consumer devices 108 will be satisfied through the local copy of the database.

In essence, then, the RSP server 102 acts as a hub for sending requests for content, receiving content, receiving preferred viewing methods and rule sets, referencing the content to a dictionary, taking content post reference to a dictionary or dictionaries and applying rule sets, assigning descriptors through a markup language, transmitting files to the consumer devices, saving user information and profiles, saving user feedback, referencing user feedback, engaging consumer device's physiological sensors etc. In this example, the RSP server 102 is separate from the consumer devices, but some or all of the RSP server functionality could be integrated into the consumer device.

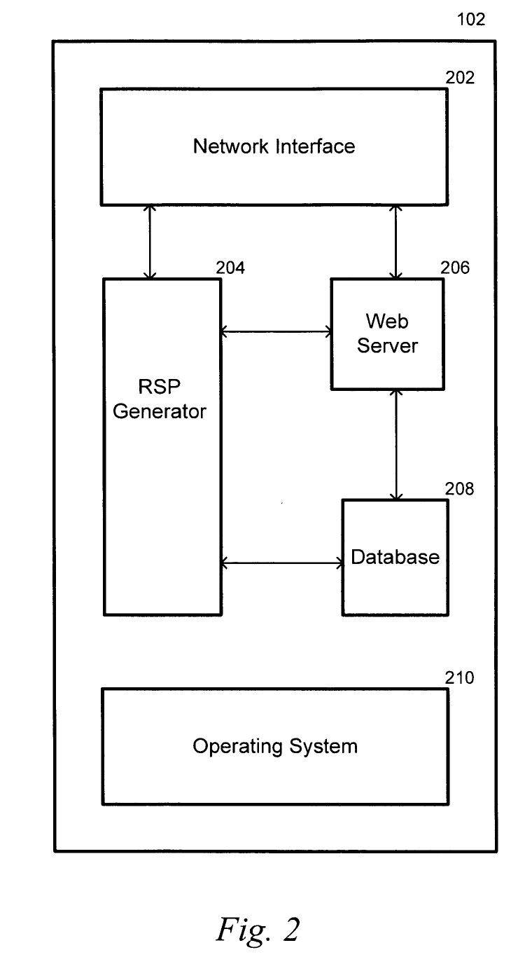

FIG. 2 is a schematic block diagram showing the relevant components of the RSP server 102 in accordance with an exemplary embodiment of the present invention. Among other things, the RSP server 102 includes a network interface 202, a RSP generator 204, a web server 206, a database 208, and an operating system 210.

The web server 206 operates as the interface through which users can personalize operation of the RSP generator 204 (e.g., by updating user profiles and selecting rule sets) and obtain content in the form of rapid serial presentations. To that end, the web server 206 receives requests from the consumer devices 108 via the network interface 202, obtains and stores content (if not already available locally), invokes the RSP generator 204 to convert content into rapid serial presentations, and distributes completed rapid serial presentations to the consumer devices 108 via the network interface 202. The web server 206 stores information (such as user profiles and content) in the database 208 for use by the RSP generator 204. The web server 206 may also receive feedback information from the consumer devices 108 regarding user preferences, actions, and measured behaviors and store such information in the database 208 for use by the RSP generator 204.

The RSP generator 204 is responsible for converting content into rapid serial presentations. To that end, the RSP generator 204 typically obtains content from the database 208 and converts the content into rapid serial presentation. As part of the conversion process, the RSP generator 204 may access dictionaries, rule sets, and/or user profiles stored in the database 208. The RSP generator 204 stores completed rapid serial presentations in the database 208 for transmittal to the consumer devices 108 by the web server 206.

The database 208 stores content, dictionaries, rule sets, user profiles, completed rapid serial presentations, and other pertinent information for use by the RSP generator 204 and web server 206. The database 208 may be integral to the RSP server 102 or be externally attached to the RSP server 102 (e.g., an external disk drive, a storage area network, or network-attached storage).

The network interface 202 provides a conduit through which the RSP generator 204 and the web server 206 send and receive information over the communications network 104. The network interface 202 may include a LAN interface, a WAN interface, or other type of interface.

The operating system 210 is an appropriate operating system that provides the general operating environment for the RSP server 102. The operating system 210 and related software runs on an appropriate processor (e.g., Windows XP running on an Intel processor). The server may utilize a 64 bit dual processor for enhanced performance, although the present invention is not limited to any particular operating system or processor. It is envisioned that the server will include at least 2 GB of RAM and at least 500 GB of storage (e.g., 250 GB for live database and at least 250 GB for maintenance, back-ups, and dumping of the database), although, again, the present invention is not limited to any particular types or amounts of memory.

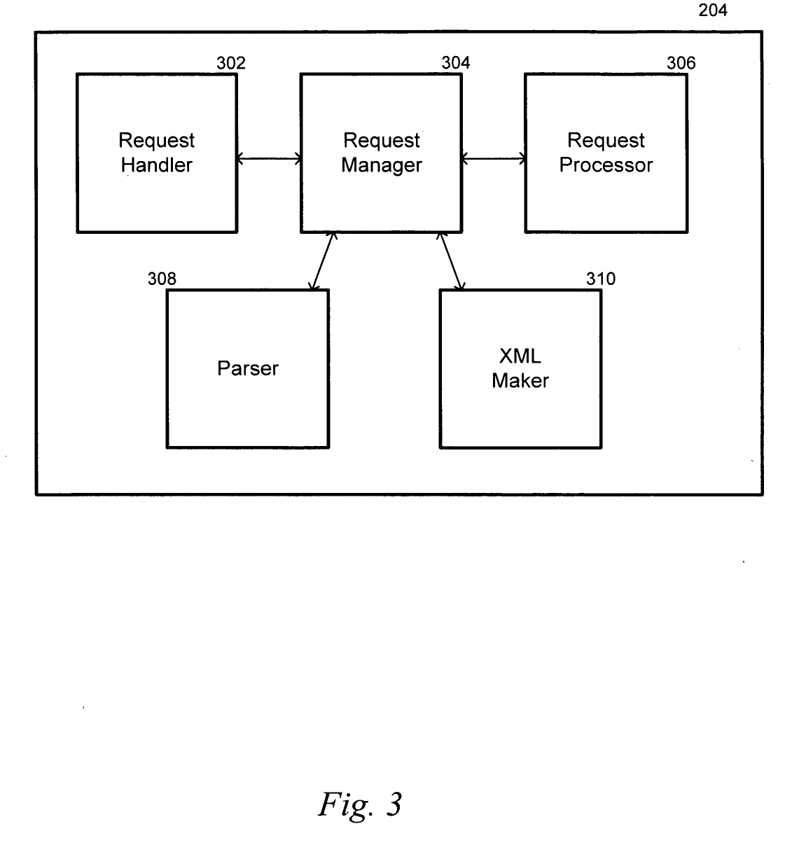

FIG. 3 is a schematic block diagram showing the relevant components of the RSP generator 204 in accordance with an exemplary embodiment of the present invention. Among other things, the RSP generator 204 includes a request handler 302, a request manager 304, a request processor 306, a parser 308, and an XML maker 310.

The request handler receives incoming request, gets the request's body of information and sends the information to the request manager. When the request manager processes the information it then sends the information with XML tags to the request handler which sends the tagged information to the client. The request manager receives content and parses it into XML with the accompanied processor requests; the request manager also authenticates the request. The request processor(s) receives the processor requests and sends the operations with the request parameters to the processor which generates a response. The XML parser receives contents and generates processor requests according to the defined scheme. The XML maker reverses the processes of the XML parser, receives processor requests and generates the XML contents.

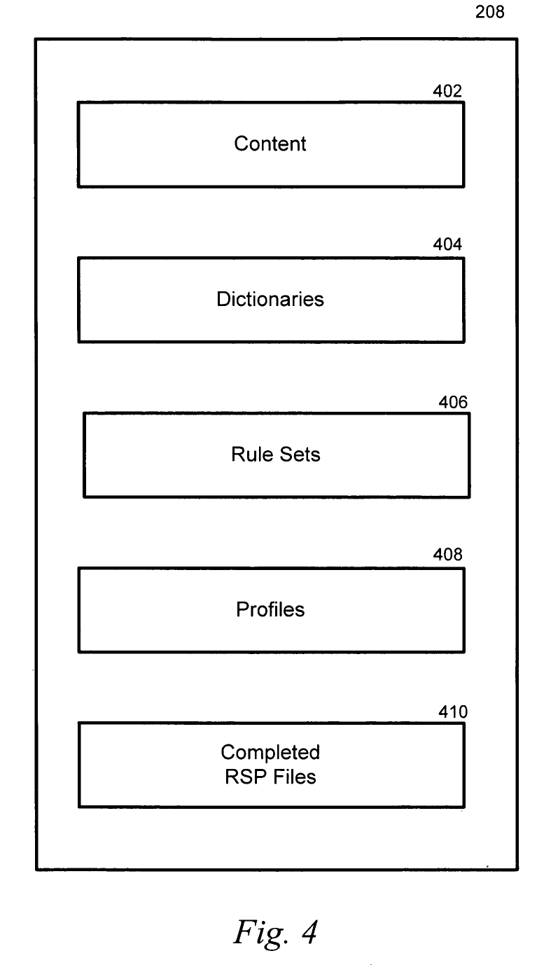

FIG. 4 is a schematic block diagram showing possible contents of the database 208 in accordance with an exemplary embodiment of the present invention. Among other things, the database 208 includes locally-stored content 402 (e.g., a local copy of a remote database), one or more dictionaries 404, various rule sets 406, user profiles 408, and completed RSP files 410.

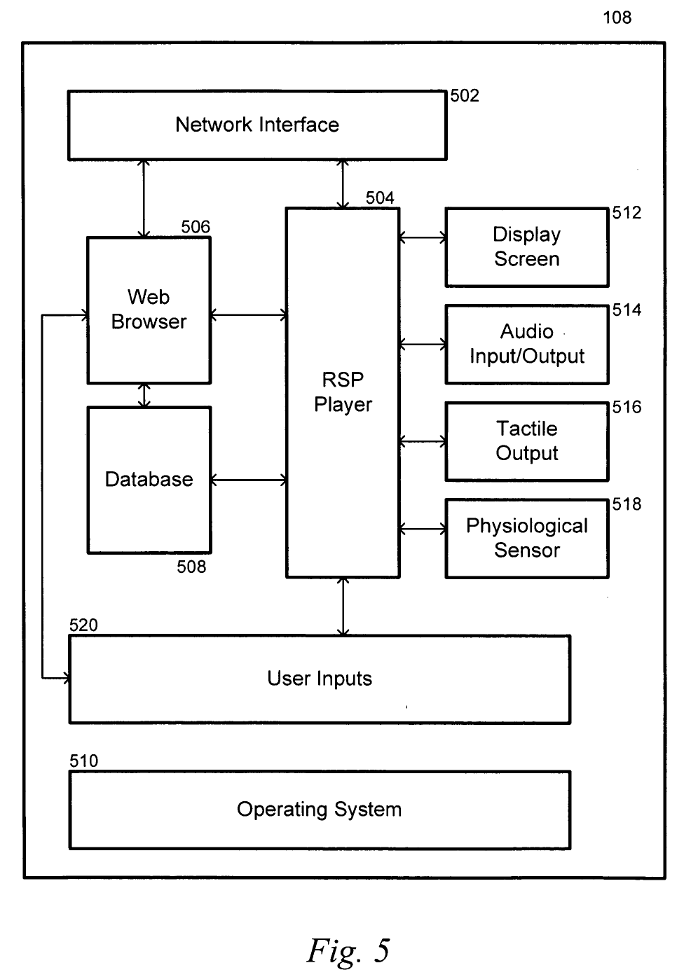

FIG. 5 is a schematic block diagram showing the relevant components of consumer device 108 in accordance with an exemplary embodiment of the present invention. Among other things, the consumer device 108 includes a network interface 502, a RSP player 504, a web browser 506, a database 508, an operating system 510, a display screen 512, an optional audio input/output 514, an optional tactile output 516, an optional physiological sensor 518, and user inputs 520.

The web browser 506 provides the main interface to the RSP server 102. Specifically, the web browser 506 sends requests to the RSP server 102 and receives back completed rapid serial presentations from the RSP server 102 over the network interface 510. The web browser 506 stores rapid serial presentations in the database 508 for access by the RSP player 504. The web browser 506 also forwards other information, such as feedback information, to the RSP server 102. The web browser 506 invokes the RSP player 504 to render a rapid serial presentation.

The RSP player 504 renders a rapid serial presentation by interpreting the various targets and descriptors and generating appropriate output signals to the display screen 512, the optional audio output 514, and the optional tactile output 516. The RSP player 504 also receives various input signals via the user inputs 520, the optional audio input 514, and the physiological sensor 518 for, among other things, controlling the rendering of the rapid serial presentation. For example, the user may manually slow down, speed up, pause, or rewind the rendering, or the RSP player 504 may automatically adjust the rendering based on analysis of inputs from the physiological sensor 518.

The network interface 502 may be a wireless interface or other interface through which the consumer device 502 communicates with the RSP server 102.

The operating system 510 is an appropriate operating system that provides the general operating environment for the consumer device 108.

The following is a sample request from the consumer device 108 to the RSP server 102 for an exemplary database search (e.g., in wikipedia):

```
  <Request>
    <Session>876ASDFSAF67969ASDF</Session> <!-Optional -->
    <Operation id=“1” name=“searchText” title=“monkey”
startIndex=“1” itemCount=“5” />
    <Operation id=“2” name=“getLinks” title=“monkey”
startIndex=“1” itemCount=“5” />
    <Operation id=“3” name=“getReferences” title=“monkey”
startIndex=“1” itemCount=“5” />
    <Operation id=“4” name=“getImages” title=“monkey”
startIndex=“1” itemCount=“5” size=“100×100” />
    <Operation id=“5” name=“Today's featured image”/>
    <!-- and so forth -->
  </Request>
```

In the above request first it is confirmed that the user is connected to the server and is ready for a search. Once a search term is entered and sent to the server, the client requests a search in each of the different areas of the database. The text is searched for finding confirmed entry titles and additional entries with the search term title present in the content. The Link title is searched to find a matching database entry in the Links, then the references pages are search, then images which are resized to the screen size of the general consumer device the client is operating on and then additional categories such as entry title, featured articles, etc.

The following is a sample response from the RSP server 102 to the consumer device 108 for the above database search:

```
  <Response>
    <Session>876ASDFSAF67969ASDF</Session> <!-Optional -->
    <Operation id=“1” name=“searchText” title=“monkey”
startIndex=“1” itemCount=“5” >
      <Item index=“1” title=“monkey” description=“” />
      <Item index=“2” title=“monkey” description=“” />
      <Item index=“3” title=“monkey” description=“” />
      <Item index=“4” title=“monkey” description=“” />
      <Item index=“5” title=“monkey” description=“” />
    </Operation>
    <Operation id=“2” name=“getLinks” title=“monkey”
startIndex=“1” itemCount=“5” >
      <Link index=“1” url=“” />
      <Link index=“2” url=“” />
      <Link index=“3” url=“” />
      <Link index=“4” url=“” />
      <Link index=“5” url=“” />
    </Operation>
    <Operation id=“3” name=“getReferences” title=“monkey”
startIndex=“1” itemCount=“5” >
      <Reference index=“1” paramsHere=“” />
      <Reference index=“2” paramsHere=“” />
      <Reference index=“3” paramsHere=“” />
      <Reference index=“4” paramsHere=“” />
      <Reference index=“5” paramsHere=“” />
    </Operation>
    <Operation id=“4” name=“getImages” title=“monkey”
startIndex=“1” itemCount=“5” size=“100×100”>
      <Image index=“1” >binary data here</Image>
      <Image index=“2” >binary data here</Image>
      <Image index=“3” >binary data here</Image>
      <Image index=“4” >binary data here</Image>
      <Image index=“5” >binary data here</Image>
    </Operation>
    <Operation id=“5” name=“today's feature image” >
      <!-- set params on our behalf -->
    </Operation>
    <!-- and so forth -->
  </Response>
```

The above response is server run coder to process confirmed matches proceeding a search of the different areas of the database. The responses are sent back to the client device starting with the article titles. Then matching links are sent back to the client. Then matching references, then images sent back in binary to be displayed and resized for the client screen and proceeding through all the general areas of data in the database.

Generating Rapid Serial Presentatives

In embodiments of the present invention, various techniques may be used alone or in combination to generate rapid serial presentations with improved characteristics that are expected to provide a more comfortable experience to the consumer.

In certain embodiments, one or more dictionaries may be referenced in order to obtain linguistic and psycholinguist attributes for various terms. Psycholinguist attributes, in particular, allow for the generation of targets and corresponding descriptors in a manner that takes into account how people actually process particular words.

In other embodiments, various rule sets may be used to generate the targets and related descriptors. Rule sets may be customized for specific consumers and/or specific types of content, and may relate to values obtained from a dictionary so as to dictate how the dictionary information is to be applied. Thus, different dictionaries and rule sets may be applied to different consumers, different types of content, and even different sections of content.

In still other embodiments, the content may be analyzed syntactically and/or semantically in order to generate targets and related descriptors that take into account the way words are used in the content. Thus, for example, the same word may be treated differently in two different contexts.

In still other embodiments, consumer profiles may be used to further customize a rapid serial presentation for a particular user. Consumer profiles may include such things as preference information provided by the consumer (e.g., preferred reading rate, dictionary, rule set, etc., which may further be specified for different types of content) and feedback information characterizing consumer experience with rapid serial presentations (e.g., information relating to a latent physiological condition of the consumer monitored during rendering of the rapid serial presentation and information relating to consumer inputs during rendering of the rapid serial presentation). Generation of targets and corresponding descriptors may take the consumer profile information into account in order to tailor the rapid serial presentation for the consumer.

In yet other embodiments, the order in which content is presented to the consumer may be determined according to the context for the rapid serial presentation and the targets and corresponding descriptors may be generated based at least in part on the determined order and the context. For example, an article about a particular medication might have sections relating to the class of drug, the drug's history (e.g., who discovered it and how), approved uses, contraindications, dosing, side effects, drug interactions, signs of drug overdose, and overdose remedies. In response to a general query about the particular medication, a rapid serial presentation might begin with the approved uses, contraindications, and dosing information followed by the other information. In response to a query received from a poison control center, however, a rapid serial presentation might begin with signs of drug overdose and overdose remedies. Such contextual processing is likely to improve the comfort level of the consumer because the consumer will not need to read or fast forward through irrelevant information.

Thus, in various embodiments of the present invention, targets and corresponding descriptors may be generated using at least one of a selected dictionary, a selected rule set, syntactic and/or semantic analysis, a consumer profile, and delivery order determined based on context. Dictionaries and rule sets may be specified by the consumer (e.g., via the consumer profile or at the time of requesting information) or selected according to the type of content (which may be determined, for example, by analyzing the content or inferring the type of content from a search term provided by the consumer).

After targets and corresponding descriptors have been generated for a rapid serial presentation, a user may be given an opportunity to manually adjust the rapid serial presentation. Specifically, an authoring tool may be provided to enable the user to modify the sequence of targets and corresponding descriptors. Such modification may include such things as converting multiple targets into a single target, converting a single target into multiple separate targets, defining/modifying characteristics for outputting a target (e.g., changing the amount of time a target is to be displayed), inserting an additional target (e.g., blank screen, audio component, video component, tactile component), and removing a target.

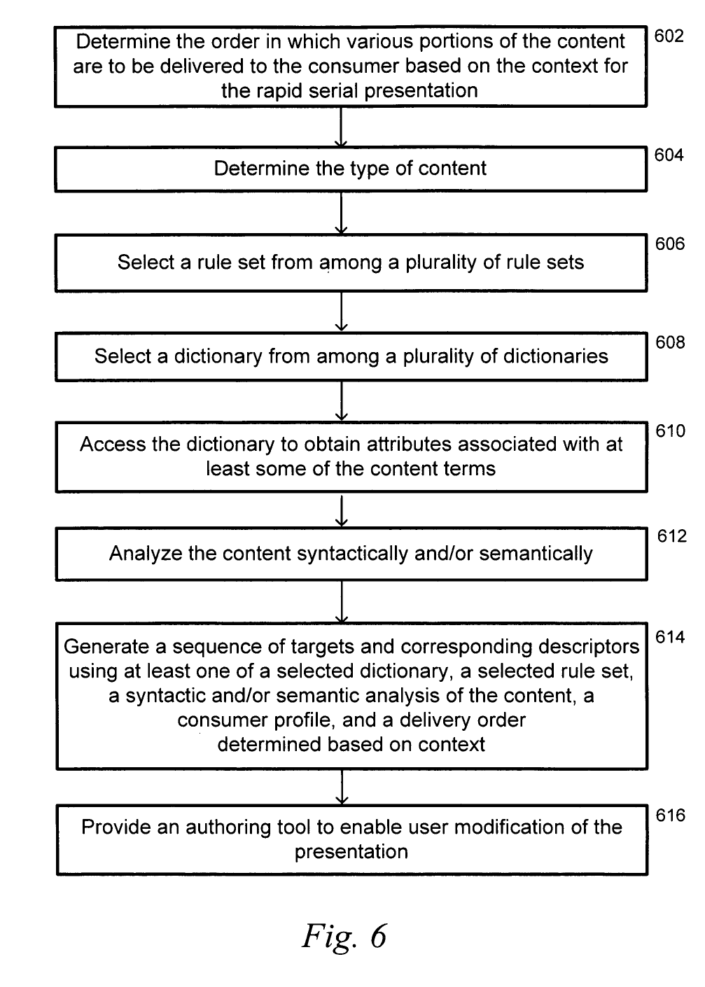

FIG. 6 is a logic flow diagram for generating targets and corresponding descriptors in accordance with exemplary embodiments of the present invention. In block 602, the order in which various portions of the content are to be delivered to the consumer may be determined based on the context for the rapid serial presentation. In block 604, the type of content may be determined. In block 606, a rule set may be selected from among a plurality of rule sets. In block 608, a dictionary may be selected from among a plurality of dictionaries. In block 610, the dictionary may be accessed to obtain attributes associated with at least some of the content terms. In block 612, the content may be analyzed syntactically and/or semantically. In block 614, a sequence of targets and corresponding descriptors may be generated using at least one of a selected dictionary, a selected rule set, a syntactic and/or semantic analysis of the content, a consumer profile, and a delivery order determined based on context. In block 616, an authoring tool may be provided to enable user modification of the presentation.

It should be noted that embodiments of the present invention may incorporate one or more of the elements represented by blocks 602, 604, 606, 608, 610, and 612 for generating a sequence of targets and corresponding descriptors for a rapid serial presentation. For example, a rule set may be used without a dictionary, a dictionary containing psycholinguistic information may be used without a rule set, dictionaries and/or rule sets may be selected with or without determining the type of content, and so on. Thus, embodiments of the present invention can include many different combinations and permutations of those elements.

Dictionaries

Oquist, Adaptive Rapid Serial Visual Presentation (2001), which was incorporated by reference above, discloses two different algorithms for presenting text on a small screen using an adaptive RSVP technique, namely a content adaptive algorithm and a context adaptive algorithm. The content adaptive algorithm uses number of words, number of characters, average word length including delimiters, and speed (in words per minute) to compute variable exposure time. The context adaptive algorithm uses the time from the content adaptation algorithm, word frequencies of the words in a chunk, and the position of the chunk in sentences being exposed. In the context adaptive algorithm, each word in a chunk is looked up in a lexicon of word frequencies and a weight is assigned to each word accordingly such that, if the word is common, it receives a weight lower than one (i.e., it is displayed for a shorter amount of time) and if it is rare or not in the lexicon, it receives a weight higher than one (i.e., it is displayed for a longer amount of time). The use of a lexicon of word frequencies in the context adaptive algorithm assumes that frequently used words can be processed by consumers more quickly than infrequently used words and so can be displayed for shorter times. In fact, word processing is affected not only by familiarity with words and their position in a sentence, but also by other perceptions (i.e., psycholinguistic attributes). Thus, for example, it may be the case that a particular frequently used word actually requires more processing time than a less frequently used word and so should be displayed for a longer amount of time. Oquist does not take such psycholinguistic attributes into account.

Therefore, in certain embodiments of the present invention, a dictionary containing psycholinguistic information is referenced in order to obtain psycholinguistic attributes for certain terms. Terms are converted into targets and corresponding descriptors using psycholinguistic attributes obtained from the dictionary. The server may maintain multiple dictionaries to be used for different consumers and/or different types of content. The use of psycholinguistic information generally allows better decisions to be made when converting terms into targets and descriptors, resulting in a rapid serial presentation that is better able to present information in a manner that reflects how the consumers are likely to process the information. For example, one could certainly envision a situation in which two words need to be displayed, a first of which has been found to be used more frequently than a second but which also has been found to be less concrete than the other. In such a situation, the use of a linguistic attribute such as “word frequency” alone would indicate that the first word should be displayed for a shorter amount of time than the second, where the additional consideration of the psycholinguistic attribute “concreteness” might suggest that the first word should actually be displayed for a longer amount of time than the second.

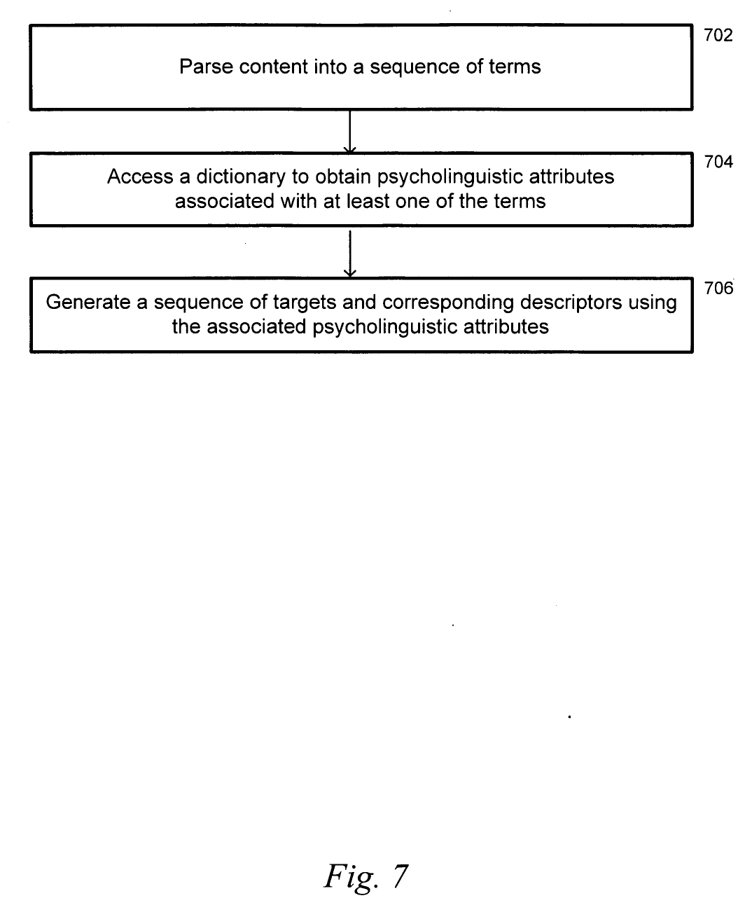

FIG. 7 is a logic flow diagram for use of a dictionary containing psycholinguistic attributes, in accordance with an exemplary embodiment of the present invention. In block 702, the content is parsed into a sequence of terms. In block 704, a dictionary is accessed in order to obtain psycholinguistic attributes associated with at least some of the terms. In block 706, the terms are converted into a sequence of targets and corresponding descriptors using the associated psycholinguistic attributes. The dictionary may be selected from among a plurality of dictionaries based on the type of content, for example, as determined by a search term provided by the consumer or by analyzing the content to determine the type of content. Alternatively, the dictionary may be selected from among a plurality of dictionaries based on a user selection, for example, as provided for in a consumer profile or in an input received from the consumer.

It should be noted that different dictionaries may be applied for different consumers and/or different types of content. A dictionary may be selected by the user or may be selected automatically by the RSP server 102. The dictionary may be accessed over the communications network 104 or may be maintained locally by the RSP server 102.

Rule Sets

In certain embodiments of the present invention, one or more rule sets can be employed when converting terms into targets and corresponding tags. A rule set is a file with a list of rules that are applied to the variables assigned to entries in a dictionary or content. A rule set offers the type of term or the precise term and the assigned outcomes that will be assigned to that term if it arises within a piece of content. Rule sets can offer general categories like familiarity ratings as well as number of syllables, context of the entry, etc. When there are multiple rules for one term, where each rule assigns an outcome, a priority of rules is referenced to find which rule within the rule set takes priority.

As mentioned above, multiple rule sets may be maintained, with each rule set configured for a particular user and/or type of content. The rule set to be applied to a given content may be specified by the user, for example, as a user input or in a user profile. Alternatively, the rule set may be selected by the RSP server 102 based on the type of content, for example, as determined by a search term provided by the user or an analysis of the content itself.

Rule sets may have different levels of granularity, e.g., rules for each word, rules for inter-sentence interactions, etc. Rule sets may include rules for model sentences or phrase structures such that text that matches a particular model may be handled according to the corresponding rule. When rule sets are used in conjunction with dictionaries, the rule sets are typically refer to values or ranges of values for attributes that can be obtained from the dictionary. For example, a rule set may have a rule based on the psycholinguistic attribute “concreteness” (e.g., if concreteness <x, display word for longer amount of time; if concreteness >=x, display word for shorter amount of time). Rule sets may include rules/filters for grouping words together and for determining the amount of time such groups of words should be displayed (e.g., computed from the amount of time each individual word would be displayed). Special rules (or separate rule sets) may be provided to handle such things as typographical errors, acronyms, words of a different language, and other anomalies encountered in the content.

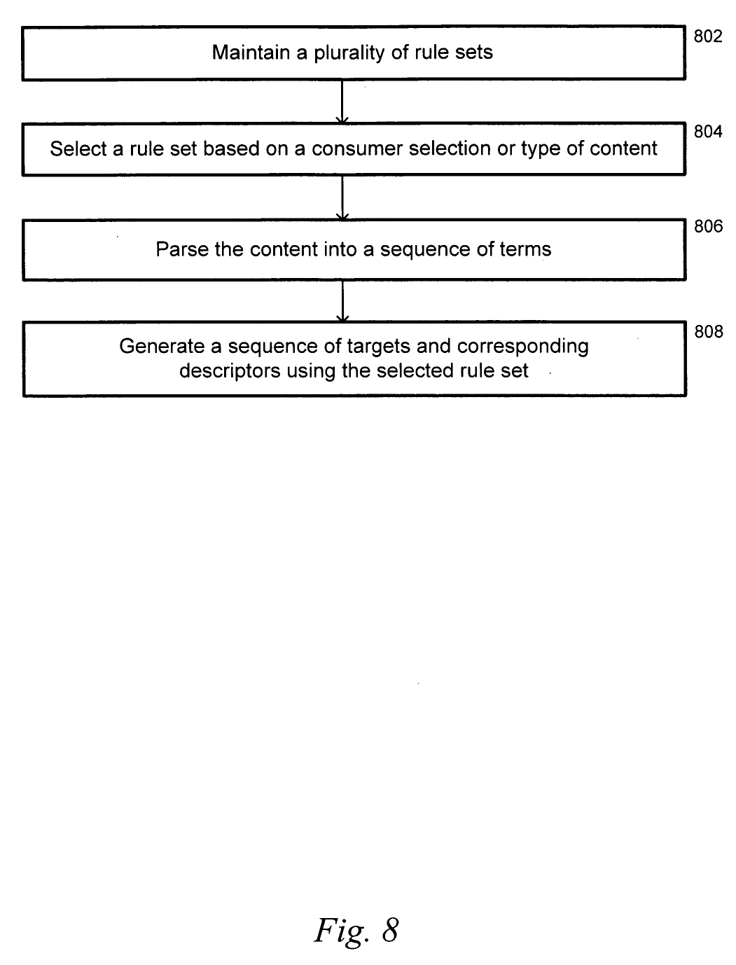

FIG. 8 is a logic flow diagram for use of rule sets, in accordance with an exemplary embodiment of the present invention. In block 802, a plurality of rule sets is maintained, where each of the rule sets defines rules for generating targets and descriptors for a different type of content. In block 804, a rule set is selected from among the plurality of rule sets based on a consumer selection or the type of content. In block 806, the contents are parsed into a sequence of terms. In block 808, the terms are converted into a sequence of targets and corresponding descriptors using the selected rule set.

The following is a list of valid filters for rules.ini that accept an integer value, in accordance with an exemplary embodiment of the present invention:
Minimum Letters
Minimum Phonemes
Minimum Syllables
Minimum Kucera Francis Frequency
Minimum Kucera Francis Categories
Minimum Kucera Francis Samples
Minimum Thorndike Lorge Frequency
Minimum Brown Verbal Frequency
Minimum Familiarity
Minimum Concreteness
Minimum Imagery
Minimum Colerado Meaningfulness
Minimum Pavio Meaningfulness
Minimum Age Of Acquisition
Maximum Letters
Maximum Phonemes
Maximum Syllables
Maximum Kucera Francis Frequency
Maximum Kucera Francis Categories
Maximum Kucera Francis Samples
Maximum Thorndike Lorge Frequency
Maximum Brown Verbal Frequency
Maximum Familiarity
Maximum Concreteness
Maximum Imagery
Maximum Colerado Meaningfulness
Maximum Pavio Meaningfulness
Maximum Age Of Acquisition
   The following is a list of additional Filters for rules.ini, in accordance with an exemplary embodiment of the present invention:
   Word Type

Valid Values: ‘None’, ‘2’, ‘Q’ or ‘2,Q’ (without the quotes)

For more information about the meaning of these values, consult the MRC2 Dictionary Documentation.

Part Of Speech Filter

A comma separated list of one or more of the following values:

Noun

Adjective

Verb

Adverb

Preposition

Conjunction

Pronoun

Interjection

Past Participle

Other

Pronouncing Dictionary Filter

A comma separated list of one or more of the following values:

Noun

Adjective

Verb

Other

Alphasyllable Filter

A comma separated list of one or more of the following values:

Abbreviation

Suffix

Prefix

Hyphenated

Multi Word

Status Filter

A comma separated list of one or more of the following values:

Dialect

Alien

Archaic

Colloquial

Capital

Erroneous

Nonsense

Nonce Word

Obsolete

Poetical

Rare

Rhetorical

Specialised

Standard

Substandard

varientPhoneme

Valid Values: One of ‘None’, ‘B’, ‘O’, ‘B,O’ (without the quotes)

For more information about the meaning of these values, consult the MRC2 Dictionary Documentation.

writtenCapitalised

Valid Values: ‘True’ or ‘False’ (without the quotes)

irregularPlural

Valid Values: ‘None’, or any combination of the letters ‘Z’, ‘Y’, ‘B’, ‘N’, ‘P’ (without the quotes).

For more information about the meaning of these values, consult the MRC2 Dictionary Documentation.

The following is a list of formatting specifiers for rules.ini, in accordance with an exemplary embodiment of the present invention:

@Bold=True

Will display the matching word in bold.

@Color=colorstring

Sets the display color of the word to the specified colorstring.

The colorstring can be any valid HTML 4 color specification.

Examples of valid values: Red, Green, Blue, Aqua, Black, #ffeedd

@Delay=n

Sets the display delay of the word to the floating-point value n.

Generally, for every x, ‘@delay=x’ is equivalent to ‘@speed=1/x’, and vice versa.

@Font=fontname

Will display the matching word using a font with the given fontname.

@Italics=True

Will display the matching word in Italics Style.

@Size=n

Will display the matching word in a font size of n. Valid values are between 1 and 7.

@Speed=n

Sets the display speed of the word to the floating-point value n.

@Underline=True

Will display the matching word underlined.

@Align=aligntype

Specifies text alignment within the display window. Possible values include left, right, center, justify.

The following is a list of valid values for ‘Additive Delay Rule’ in [Default] in rules.ini, in accordance with an exemplary embodiment of the present invention:

rightmost

Takes the delay value of the rightmost word.

leftmost

Takes the delay value of the leftmost word.

limit: n

Takes the minimum between the floating-point value ‘n’ and the sum of the delays of all the words.

limit: max*n

Equivalent to ‘limit x’ where x=n*(maximum amongst the delay values)

For instance, if the delay list of a set of three words is [2 ,4, 5], using the Additive Delay Rule of ‘limit: max*1.5’ will be equivalent to ‘limit: 7.5’(5 is the maximum amongst the delay values, and 5*1.5=7.5).

subtract: n2, n3, n4, . . .

For a delay list of length 1, will use the following additive delay value calculation: ((sum of delays)−n1)

For instance, using the Additive Delay Rule of ‘subtract: 1, 1.5’for the delay list [2, 2.5, 3], the length of the delay list is 3, so the subtracted value will be n3=1.5, and the calculated delay value will be:
(2+2.5+3)−1.5=6
multiply: n2, n3, n4, . . .

For a delay list of length 1, will use the following additive delay value calculation: ((sum of delays)*n1)

For instance, using the Additive Delay Rule of ‘multiply: 0.8, 0.75, 0.7’ for the delay list [2, 2.5, 3], the length of the delay list is 3, so the multiplier will be n3=0.75, and the calculated delay value will be:
(2+2.5+3)*0.75=5.625

The following is a first exemplary rule set. The default set of rules specifies guidelines for the minimum (12) and maximum (16) number of letters to be displayed as a unit (if these guidelines cannot be met, then the RSP server 102 will create a target a close as possible to those guidelines), specifies the maximum additive delay value to be assigned to a word grouping to be no more than two times the display speed associated with the word having the largest display speed, and specifies the default font size to be six. The next set of rules specifies that words that are determined to be in the category of “dialect” are to be displayed in black with a priority over other color applications. The next set of rules specifies that nouns are to be displayed in blue and are to be assigned a display speed of 0.85 times the default value of one. The next set of rules specifies that verbs and adverbs are to be displayed in red and are to be assigned a display speed of 1.30 times the default value of one. The next set of rules specifies that words having more than five letters are to be displayed in black. The next set of rules specifies that adjectives are to be displayed in bold and are to be assigned a display speed of 1.4 times the default value of one. The final set of rules (which has the lowest priority) specifies that verbs are to be underlined.

| | |
|---|---|
| [default] | |
| Minimum letters = | 12 |
| Maximum letters = | 16 |
| Additive Delay Rule = | limit: max * 2 |
| @size = | 6 |
| [First Rule Name] | |
| Status Filter = | Dialect |
| @Color = | black |
| [Second Rule Name] | |
| Part Of Speech Filter = | Noun |
| @Color = | blue |
| @Speed = | 0.85 |
| [Rule Name 3] | |
| Part Of Speech Filter = | Verb, Adverb |
| @Color = | red |
| @Speed = | 1.30 |
| [Rule Name 4] | |
| Minimum letters = | 5 |
| @color = | black |
| [Rule Name 5] | |
| Part Of Speech Filter = | Adjective |
| @Bold = | true |
| @speed = | 1.4 |
| [Rule Name 6] | |
| Part Of Speech Filter = | Verb |
| @Underline = | True |

Thus, for example, if the above rule set were applied to the word grouping “the quick fox,” the word “the” would be displayed in black and would be assigned the default display speed of 1, the word “quick” would be displayed in bold and would be assigned a display speed of 1.4 (based on [Rule Name 5]), and the word “fox” would be displayed in blue and would be assigned a display speed of 0.85 (based on [Second Rule Name]). The display speeds for the three words add up to 3.25, but the word grouping as a unit would be assigned a display speed of 2.8 (i.e., two times the maximum display speed of 1.4, based on the [default] additive delay rule).

The following is a second exemplary rule set in which display speeds are specified for different parts of speech. Specifically, the display speeds are specified as follows: Noun=1.0, Adjective=1.4, Verb=1.3, Adverb=1.4, Preposition=1.0, Conjunction=0.8, Pronoun=0.9, Interjection=1.5, Past Participle=1.5; other words are displayed at 1.0 but are turned red. This rule set might act as a good base for developing a user profile for a user by adjusting the values to the preferences of the user and the content being displayed.

| | |
|---|---|
| [First Rule Name] | |
| Part of Speech Filter = | Noun |
| @Speed = | 1.0 |
| [Second Rule Name] | |
| Part of Speech Filter = | Adjective |
| @Speed = | 1.4 |
| [Third Rule Name] | |
| Part of Speech Filter = | Verb |
| @Speed = | 1.3 |
| [Fourth Rule Name] | |
| Part of Speech Filter = | Adverb |
| @Speed = | 1.4 |
| [Fifth Rule Name] | |
| Part of Speech Filter = | Preposition |
| @Speed = | 1.0 |
| [Sixth Rule Name] | |
| Part of Speech Filter = | Conjunction |
| @Speed = | .8 |
| @Italics = | True |
| [Seventh Rule Name] | |
| Part of Speech Filter = | Pronoun |
| @Speed = | .9 |
| [Eighth Rule Name] | |
| Part of Speech Filter = | Interjection |
| @Speed = | 1.5 |
| [Ninth Rule Name] | |
| Part of Speech Filter = | Past Participle |
| @Speed = | 1.5 |
| [Tenth Rule Name] | |
| Part of Speech Filter = | Other |
| @Speed = | 1.0 |
| @Color = | Red |

The following is a third exemplary rule set. The default set of rules specifies guidelines for the minimum (12) number of letters in a word grouping, the maximum (16) number of letters in a word grouping, and default font size. The next set of rules specifies that capitalized words are to be underlined and are to be assigned a display speed of 0.85. The next set of rules specifies right-justification of text within the display window. The next set of rules specifies that words having an “age of acquisition” value greater than or equal to twelve be assigned a display speed of 1.5. The next set of rules specifies that single-syllable words are to be displayed in green italics and are to be assigned a display speed of 0.6. The next set of rules specifies that the second word in the groupings delay value will be doubled. The final set of rules specifies that a word grouping is to be assigned a display speed equal to the sum of the individual word display speeds minus 0.8.

| | |
|---|---|
| [default] | |
| Minimum letters = | 12 |
| Maximum letters = | 16 |
| @size = | 6 |
| [First Rule Name] | |
| WrittenCapitalised = | True |
| @Speed = | .85 |
| @Underline = | True |
| [Second Rule Name] | |
| @Align = | right |
| [Third Rule Name] | |
| Minimum Age of Acquisition = | 12 |
| @Speed = | 1.5 |
| [Fourth Rule Name] | |
| Maximum syllables = | 1 |
| @Speed = | .6 |
| @Color = | green |
| @Italics = | True |
| [Fifth Rule Name] | |
| Additive Delay Rule = | multiply: 1, 2, 1 |
| [Sixth Rule Name] | |
| Additive Delay Rule = | Subtract: .8 |

The following is a fourth exemplary rule set. The default set of rules specifies guidelines for the minimum (12) number of letters in a word grouping, the maximum (16) number of letters in a word grouping, and default font size. The next set of rules specifies that words having a familiarity values greater than or equal to 500 be assigned a display speed of 0.75. The next set of rules specifies that words having a concreteness value less than or equal to 400 be assigned a display speed of 0.84 (concreteness refers the ability of the user to have a grasp on the content; a not so concrete word might be “truth,” while a word that is more concrete is “pencil”). The next set of rules specifies that words having a familiarity value less than or equal to 499 be assigned a display speed of 1.3. The next set of rules specifies that pronouns are to be assigned a display speed of 1.3. The last set of rules specifies that irregular plurals that are in their plural form (z), singular form (y), or both their singular and plural form (b) are to be displayed in red bold and are to be assigned a display speed of 1.3.

| [Default] | |
|---|---|
| Minimum letters = | 12 |
| Maximum letters = | 16 |
| @size = | 10 |
| [First Rule Name] | |
| Minimum Familiarity = | 500 |
| @Speed = | .75 |
| [Second Rule Name] | |
| Maximum Concreteness = | 400 |
| @Speed = | .84 |
| [Third Rule Name] | |
| Maximum Familiarity = | 499 |
| @Speed = | 1.3 |
| [Fourth Rule Name] | |
| Part of Speech Filter = | Pronoun |
| @Speed = | 1.3 |
| [Fifth Rule Name] | |
| irregularplural = | zyb |
| @Bold = | True |
| @Color = | Red |
| @Speed = | 1.3 |

The following is a fifth exemplary rule set. The default set of rules specifies guidelines for the minimum (12) number of letters in a word grouping, the maximum (18) number of letters in a word grouping, and default font size. The next rule set specifies that words having an imagery value less than or equal to 200 are to be assigned a display speed of 1.8. The next set of rules specifies words having a Brown verbal frequency value less than or equal to 40 are to be assigned a display speed of 1.4. The next set of rules specifies that words having a Thorndike Lorge frequency value greater than or equal to 60 are to be assigned a display speed of 0.9. The next set of rules specifies that words with four syllables or more are to be assigned a display speed of 1.6. The next set of rules specifies that words having a word type value “2,q” are to be displayed in italics. The next set of rules specifies that verbs are to be displayed in blue. The next two sets of rules specify that words characterized as either “nonsense” or “substandard” are to be displayed in red. Such a rule set might be useful, for example, for a non skilled language speaker who needs additional time for infrequently used words, longer words, words that are harder to imagine, and words having a low meaningfulness rating.

| | |
|---|---|
| [Default] | |
| Minimum letters = | 12 |
| Maximum letters = | 18 |
| @size = | 6 |
| [First Rule Name] | |
| Maximum Imagery = | 200 |
| @Speed = | 1.8 |
| [Second Rule Name] | |
| Maximum Brown Verbal Frequency = | 40 |
| @Speed = | 1.4 |
| [Third Rule Name] | |
| Minimum Thorndike Lorge Frequency = | 60 |
| @Speed = | .9 |
| [Fourth Rule Name] | |
| Minimum Syllables = | 4 |
| @Speed = | 1.6 |
| [Fifth Rule Name] | |
| Word Type = | 2, q |
| @Italics = | True |
| [Sixth Rule Name] | |
| Part of Speech Filter = | Verb |
| @Color = | Blue |
| [Seventh Rule Name] | |
| Status Filer = | Nonsense |
| @Color = | Red |
| [Eighth Rule Name] | |
| Status Filter = | Substandard |
| @Color = | Red |

The following is a sixth exemplary rule set that generates a rapid serial visual presentation with regular delays, the same for each target but with in 10-20 letter chunks. Also the font size is specified and the font is specified.

| | |
|---|---|
| Minimum letters = | 10 |
| Maximum letters = | 20 |
| @size = | 18 |
| @font = | Times New Roman |

It should be noted that, in exemplary embodiments of the present invention, the display speed (i.e., @Speed) values are relative to a value of one, which indicates a nominal display speed selected by or for the consumer. For example, if @Speed=0.85, then the display speed will be 85% of the nominal display speed; if @Speed=1.25, then the display speed will be 125% of the nominal display speed.

In exemplary embodiments of the invention, the rule sets are “insertable” such that the RSP generator 102 essentially plugs a selected rule set into the logic and applies the specified rules.

It should be noted that the filters, specifiers, and overall syntax for rule sets described above are exemplary only. The present invention is in no way limited to any particular types or forms of filters, filter values, specifiers, specifier values, syntax, or other rule set specifics. Thus, for example, additional constructs may be included for specifying exact values or ranges of values rather than minimum and maximum values (e.g., rather than, or in addition to “minimum concreteness” and “maximum concreteness,” could have constructs for “concreteness=n” and/or “concreteness=[n1,n2],” where n1 is a lower bound for a range and n2 is an upper bound for the range). Furthermore, mechanisms may be defined for implicitly or explicitly defining priorities among various rules.

Authoring Tool

An authoring tool may be used to create or modify a rapid serial presentation. In order to create a rapid serial presentation, the authoring tool generally parses the content into a sequence of terms and associates each term with a default set of characteristics. The terms are presented to the user, and the user is given the ability to change various characteristics of the presentation, such as word groupings and display characteristics. The user is also given the ability to add additional targets to the presentation, for example, audio components, video components, image component, tactile components, or blank screens. Similarly, the authoring tool may be presented to the user after generation of a sequence of targets and corresponding descriptors in order to provide the user with an opportunity to manually edit the presentation.

Voice-To-Text

Wong, Visible Language Workshop paper, which is hereby incorporated herein by reference in its entirety, discusses dynamic visual treatment of text as an extension of written language. Wong defines “typography” as the visual treatment of written language to enrich visual communication. Wong recognizes that a range of emotional qualities and tones of voice can be conveyed through treatment of the typographical form (e.g., typeface, weight, color) and also recognizes that electronic media extends the expressive possibilities by enabling typographic forms to change dynamically in size, color, and position according to a writer's expression or a reader's interaction in real time. A software tool called “exPress” and an associated scripting language that allows manipulation of typographic attributes, such as size, weight, position, transparency, color, dynamic typographic changes (e.g., a word grows in size or moves over time) are described. The exPress tool allows control over the speed at which the information is presented such that, for example, two tones of voice can be visually represented using different rhythms.

In theory, Wong's exPress tool allows a user to generate a RSVP that mimics the way in which text would be verbalized. In practice, however, it is very difficult to generate such a RSVP. Therefore, in certain embodiments of the present invention, textual content is read and recorded, the recorded reading is analyzed to identify verbal characteristics (e.g., voice inflections, word breaks, decibel strengths, and syllable stresses), the textual content is parsed into a sequence of terms, and the a sequence of targets and corresponding tags is generated from the terms using the verbal characteristics, so that a rapid serial visual presentation of the targets will mimic at least in part the verbal characteristics. In some cases, people say words quicker verbally than can be sensed visually as a comfortable reading experience. For such overly short words, the RSP server 102 would generally adjust the rate of visual presentation to complement reading processes in the rapid serial presentation.

One possible use for such a text-to-speech technique is for converting verbal messages (e.g., voice mail) into a textual message for a portable consumer device.

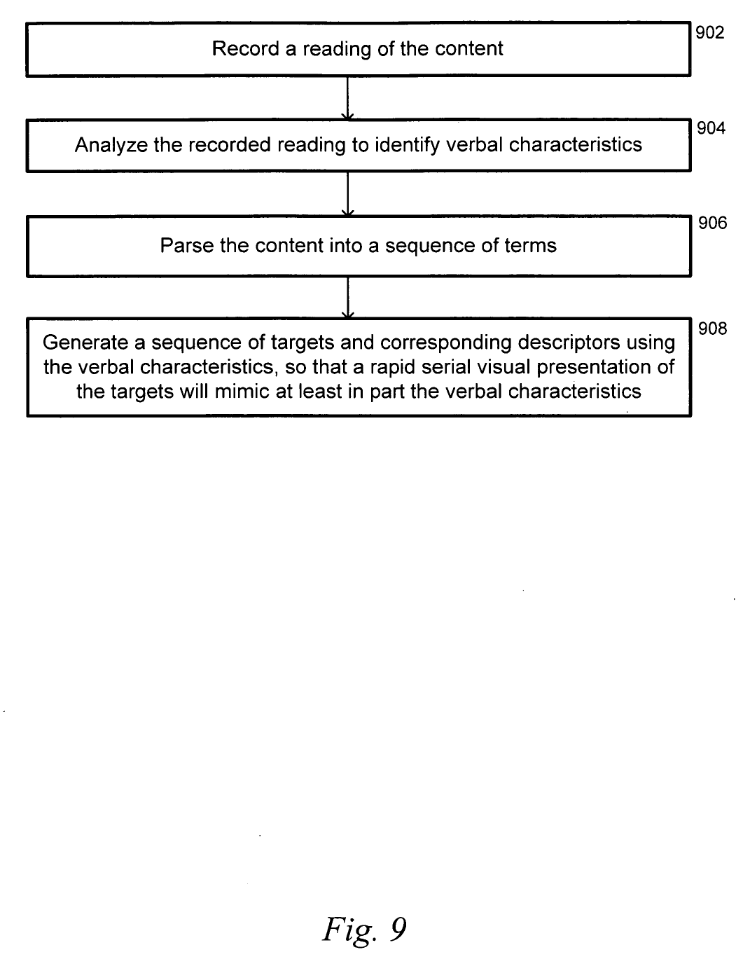

FIG. 9 is a logic flow diagram for text-to-speech in accordance with an exemplary embodiment of the present invention. In block 902, a reading of the content is recorded. In block 904, the recorded reading is analyzed to identify verbal characteristics. In block 906, the content is parsed into a sequence of terms. In block 908, a sequence of targets and corresponding descriptors is generated using the verbal characteristics, so that a rapid serial visual presentation of the targets will mimic at least in part the verbal characteristics.

Biofeedback

Akervall, Smart Bailando Eye controlled RSVP on handhelds (2002), which was incorporated by reference above, discloses an RSVP player that is controlled in part by eye position. A pair of cameras monitors the position of the user's face and eyes and dynamically controls the RSVP presentation based on eye movements. For example, if the user looks away from the screen, the rate of text presentation may be temporarily reduced. As discussed in the article, monitoring eye position can be very difficult because it relies on two cameras and also relies to a large extent on the user remaining stationary. While some consumer devices include a single camera, very few (if any) include two cameras, and it would generally be impractical to incorporate two cameras into most consumer devices due to both space and cost constraints. Thus, eye control of RSVP presentations is not realistic.

Therefore, in certain embodiments of the present invention, a physiological sensor is incorporated into the consumer device. The physiological sensor can be used to monitor a latent physiological condition of the consumer, such as heart rate, blood flow, brain waves, electronic signals, galvanic skin response, breathing, temperature, and other latent physiological conditions. The physiological condition is analyzed in order to infer an emotional state of the consumer with regard to the presentation. The physiological condition and/or information about the inferred emotional state may be used locally by the consumer device 108 to dynamically adjust the presentation and/or may be sent back to the RSP server 102 for use in generating subsequent presentations for the consumer.

In an exemplary embodiment, the physiological sensor may include an infrared transducer onto which the consumer places a finger. The infrared transducer is typically positioned at a location where one of the consumer's fingers would normally be placed during normal operation of the consumer device (e.g., while holding a cell phone or PDA). The infrared transducer may be used to monitor the consumer's heart rate, blood flow, etc. Alternatively or additionally, the sensor may include one or more electrodes for generating and/or measuring electrical signals, such as for measuring galvanic skin response of the consumer. Alternatively or additionally, the sensor may include an antenna for monitoring brain waves or other electromagnetic activity emanating from the consumer. Alternatively or additionally, the sensor may include a thermometer for measuring the consumer's temperature.

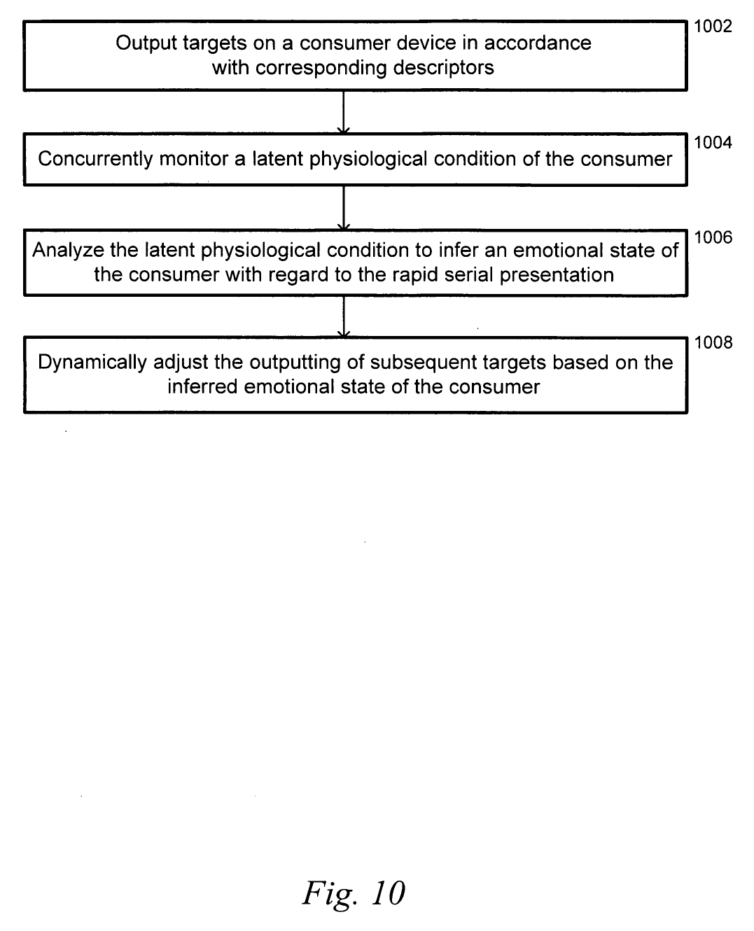

FIG. 10 is a logic flow diagram for biofeedback in accordance with an exemplary embodiment of the present invention. In block 1002, targets are output on a consumer device in accordance with corresponding descriptors. In block 1004, a latent physiological condition of the consumer is monitored concurrently. In block 1006, the latent physiological condition is analyzed to infer an emotional state of the consumer with regard to the rapid serial presentation. In block 1008, the outputting of subsequent targets is dynamically adjusted based on the inferred emotional state of the consumer. In block 1010, feedback information relating to the latent physiological condition may be transmitted to the presentation server for use in generating a subsequent rapid serial presentation for the consumer.

RSVP Player Embedded in Browser

In certain embodiments of the present invention, an RSP player in embedded in a web browser. In such embodiments, the consumer generally uses the web browser to find information of interest. The user might then highlight the portion to be displayed using RSP and then either right-click to access an RSP control screen or click on a preview button on the menu bar where a small RSVP target location would display the text and an additional button that take RSVP into a large screen or full screen view. An RSP player could similarly be integrated with other applications, such as word processors. The RSP player could add audio components, video components, image components, or tactile components to the presentation. The integrated RSP player may include a mechanism by which the user can switch between rapid serial presentation and traditional textual display modes.

Embedded Advertisements

As mobile devices become increasingly more common the sale of content for those mobile devices has also become more popular. One of the fundamental constraints of mobile devices is their screen size. The constraint of screen size has been a barrier to advertisers trying to have their ads viewed on mobile devices. Embodiments of the present invention can provide an opening into this currently untapped market of advertising on mobile devices by incorporating advertisements into rapid serial presentations. For example, a number of advertisements may be included at the beginning of the rapid serial presentation. The price charged to a consumer for a rapid serial presentation could be gated on the number of advertisements the consumer is willing to view. For example, full price might be charged if the consumer is unwilling to view advertisements, while increasing discounts might be provided for increasing numbers of advertisements. Mechanisms can be provided to ensure that the advertisements are actually viewed by the consumer, for example, by requiring the consumer to take an action (e.g., click the mouse) within a predetermined amount of time following an advertisement.

Conclusion

Although RSP was developed with an eye toward small screen consumer devices, the present invention is not limited to such use, and the RSP techniques described below could be equally applied to larger screen devices, which may be particularly useful for people with impaired vision, dyslexia, learning disabilities, and other conditions.

It should be noted that the logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, the RSP generator 204 and RSP player 504 are implemented in Java with JDK 1.5.0.6.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and intemetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

### APPENDIX A

### MRC Psycholinguistic Database: Machine Usable Dictionary. Version 2.00

### Informatics Division Science and Engineering Research Council Rutherford Appleton Laboratory Chilton, Didcot, Oxon, OX11 0QX Michael Wilson 1 Apr. 1987

MRC Machine Usable Dictionary. Version 2.00

The MRC Psycholinguistic Database version 1, was provided as an on-line service (see Coltheart, 1981b). The service drew on three files and several access programs. The first file was a dictionary of words, the second and third files were sets of word association norms from the Edinburgh Thesaurus. The service has now been discontinued.

This second version of the MRC Psycholinguistic Database is being provided as a computer usable resource rather than as a service. An updated version of the dictionary file from the database (referred to here as MRC2.DCT) is being provided for public research use along with some programs which can be used either to access the dictionary, or as examples on which to model programs which match users' specific needs. This database dictionary differs from other machine usable dictionaries in that it includes not only syntactic information but also psychological data for the entries (see Amsler, 1984 for a review of other machine-readable dictionaries). It also differs from most conventional dictionaries in that it does not currently attempt to provide any semantic information. It is designed to be of use to psycholinguists in selecting stimulus materials for testing; for use by researchers in Artificial Intelligence as a source of information required for natural language processing and cognitive simulation; and for use by computer scientists who wish to use the word lists and syntactic information in the design of text processors.

The MRC Psycholinguistic Database: Machine Usable Dictionary and utility programs are available for research purposes from the Oxford Text Archive as item 1054 on their list at a nominal fee to cover handling costs. Their address is:

Oxford Text Archive

Oxford University Computing Service

13 Banbury Road,

Oxford OX2 6NN

U.K.

Tel: Oxford (0865) 56721

JANET electronic mail address: ARCHIVE@UK.AC.OX.VAX3

The Machine Usable Dictionary File.

The file contains 150837 words and provides information about 26 different linguistic properties, although it is not the case that information about every property is available for every one of the 150837 words: nobody, for example, has yet collected imagery ratings on such a large set of words, and thus only 9240 of the words possess an imagery rating.

The dictionary file does not contain any information which is original to it, but was assembled by merging a number of smaller databases of limited availability:
the tape dictionary of Dolby, Resnikoff and MacMurray (1963) which was created by taking all the left justified bold faced words from the Shorter Oxford English Dictionary together with the parts of speech given by that dictionary. In addition, words were taken from the Cornell University tape of 20,000 commonly used words, and the parts of speech for all these words found in the third edition of Webster's New International Dictionary.
the Edinburgh Associative Thesaurus (Kiss, Armstrong, Milroy and Piper, 1973);
the Colerado Norms (Toglia and Battig, 1978);
the Pavio Norms (unpublished, these are an expansion of the norms of Pavio, Yuille and Madigan, 1968);
the Gilhooly-Logie norms (Gilhooly and Logie, 1980);
the Kucera-Francis written frequency count (Kucera and Francis, 1967);
the Thorndike-Lorge written frequency count (Thorndike and Lorge, 1944; L count);
the phonetic transcriptions from Daniel Jones' Pronouncing Dictionary of English Language, 12th Edition (see Guierre, 1966).
2500 proper names from the Machine Usable Version of the Oxford Advanced Learner's Dictionary (Mitton, 1986) which were added to the published version of the dictionary and are not covered by the copyright held by the Oxford University Press.
The frequency count for spoken English from the London-Lund Corpus of English Conversation (Svartvik and Quirk, 1980; Brown, 1984).

The dictionary file currently occupies 11 Mbyte as a sequential plain text file. Each line of the file represents the field for one word. The longest entry is 130 characters; e.g.

040320021615167000000093057530228435500000 JJ SABLE|eI/b1|eIb|20

The composition of the dictionary file is summarised in Table 1, which specifies the linguistic properties described in an entry. The first column of Table 1 indicates the columns/field in the file containing the data. The last four properties are held in variable length fields separated by a | character. The second column indicates the name of the data field used elsewhere in programs and documentation. The third column specifies the identity of the linguistic property, and the fourth column indicates the number of words in the database for which information about a particular linguistic property is available. The first fourteen properties are stored in the file as numerical values. For these properties, the occurrence count refers to the number of non zero entries.

TABLE 1
The Dictionary File.

| COLUMN | NAME | PROPERTY | OCCURRENCES |
|---|---|---|---|
| 1-2 | NLET | Number of letters in | 150837 |
| | | the word | |
| 3-4 | NPHON | Number of phonemes | 38438 |
| | | in the word | |
| 5 | NSYL | Number of syllables | 89402 |
| | | in the word | |
| 6-10 | K-F-FREQ | Kucera and Francis | 29778 |
| | | written frequency | |
| 11-12 | K-F- | Kucera and Francis | 29778 |
| | NCATS | number of categories | |
| 13-15 | K-F- | Kucera and Francis | 29778 |
| | NSAMP | number of samples | |
| 16-21 | T-L-FREQ | Thorndike-Lorge | 25308 |
| | | frequency | |
| 22-25 | BROWN- | Brown verbal | 14529 |
| | FREQ | frequency | |
| 26-28 | FAM | Familiarity | 9392 |
| 29-31 | CONC | Concreteness | 8228 |
| 32-34 | IMAG | Imagery | 9240 |
| 35-37 | MEANC | Mean Colerado | 5450 |
| | | Meaningfulness | |
| 38-40 | MEANP | Mean Pavio | 1504 |
| | | Meaningfulness | |
| 41-43 | AOA | Age of Acquisition | 3503 |
| 44 | TQ2 | Type | 44976 |
| 45 | WTYPE | Part of Speech | 150769 |
| 46 | PDWTYPEPD | Part of Speech | 38390 |
| 47 | ALPHSYL | Alphasyllable | 15938 |
| 48 | STATUS | Status | 89550 |
| 49 | VAR | Varient Phoneme | 1445 |
| 50 | CAP | Written Capitalised | 4585 |
| 51 | IRREG | Irregular Plural | 23111 |
| \| | WORD | the actual word | 150837 |
| \| | PHON | Phonetic Transcription | 38420 |
| \| | DPHON | Edited Phonetic | 136982 |
| | | Transcription | |
| \| | STRESS | Stress Pattern | 38390 |

Some of the properties listed in Table 1 are obvious; others require explanation as follows:

NLET

The distribution of entries in the WORD filed by the number of letters that they contain is shown in Table 2.

TABLE 2
The Distribution of Word Lengths Given by NLET.

| NUMBER OF | |
|---|---|
| OCCURRENCES | NLET |
| 31 | 1 |
| 168 | 2 |
| 1342 | 3 |
| 4719 | 4 |
| 10199 | 5 |
| 16818 | 6 |
| 21118 | 7 |
| 22302 | 8 |
| 20426 | 9 |
| 16409 | 10 |
| 11697 | 11 |
| 7566 | 12 |
| 4451 | 13 |
| 2342 | 14 |
| 1158 | 15 |
| 479 | 16 |
| 250 | 17 |
| 81 | 18 |
| 32 | 19 |
| 14 | 20 |
| 4 | 21 |
| 1 | 22 |
| 2 | 23 |

NPHON

The distribution of entries in the WORD field by the number of phonemes that they contain is shown in Table 3.

NSYL

The distribution of entries in the WORD field by the number of phonemes that they contain is shown in Table 4.

K-F-FREQ, K-F-NCATS, K-F-NSAMP

The first of these refer to a word's frequency of occurrence as given in the norms of Kucera and Francis (1967). The maximum frequency in the file is 69971, the minimum is 0. The meaning of K-F-NCATS and K-F-NSAMP are defined by Kucera and Francis (1967).

TABLE 3
The Distribution of Phoneme Counts Given by NPHON.

| NUMBER OF | |
|---|---|
| OCCURRENCES | NPHON |
| 109060 | 0 |
| 32 | 1 |
| 276 | 2 |
| 1442 | 3 |
| 3396 | 4 |
| 4561 | 5 |
| 4985 | 6 |
| 4691 | 7 |
| 4199 | 8 |
| 3317 | 9 |
| 2429 | 10 |
| 1536 | 11 |
| 862 | 12 |
| 450 | 13 |
| 206 | 14 |
| 110 | 15 |
| 42 | 16 |
| 9 | 17 |
| 3 | 18 |
| 3 | 19 |

TABLE 4
The Distribution of Syllable Counts Given by NSYL.

| NUMBER OF | |
|---|---|
| OCCURRENCES | NSYL |
| 58081 | 0 |
| 12485 | 1 |
| 32837 | 2 |
| 27751 | 3 |
| 14159 | 4 |
| 4530 | 5 |
| 856 | 6 |
| 134 | 7 |
| 14 | 8 |
| 1 | 9 |

T-L-FREQL

This is the frequency of occurrence as given in the L count of Thorndike and Lorge (1942). If you plan to use this frequency count, you are advised to read details about it in the Thorndike-Lorge book. For example, the frequency value of a singular word which has a regular plural includes the frequency of the plural form, and this is true for other kinds of derivations too.

BROWN-FREQ

This stands for the frequency of occurrence in verbal language derived from the London-Lund Corpus of English Conversation by Brown (1984). There are 14529 entries for 8985 different strings in the WORD field. The range of entries is 0-6833 with a mean of 35 and a standard deviation of 252.

FAM

This stands for ‘printed familiarity’. The FAM values were derived from merging three sets of familiarity norms: Pavio (unpublished), Toglia and Battig (1978) and Gilhooly and Logie (1980). The method by which these three sets of norms were merged is described in detail in Appendix 2 of the MRC Psycholinguistic Database User Manual (Coltheart, 1981a). This method may not meet with everyone's approval. FAM values lie in the range 100 to 700 with the maximum entry of 657, a mean of 488 and a standard deviation of 99: note that they are integer values (in the original norms the equivalent range was 1.00 to 7.00).

CONC

This is concreteness, and it too is derived from a merging of the Pavio, Colerado, and Gilhooly-Logie norms: details of merging are given in Appendix 2 of the MRC Psycholinguistic Database User Manual (Coltheart, 1981a). CONC values are integer, in the range 100 to 700 (min: 158; max 670; mean 438; s.d. 120).

IMAG

This is imageability, derived from merging the three sets of norms referred to above, and having values in the range 100 to 700 (min 129; max 669; mean 450; s.d. 108).

MEANC

These are the meaningfulness ratings from the Toglia and Battig (1978), multiplied by 100 to produce a range from 100 to 700 (min 127; max 667; mean 415; s.d. 78).

MEANP

This is the meaningfulness from the norms of Pavio (unpublished) multiplied by 100 to produce a range from 100 to 700. The two sets of meaningfulness ratings were not merged because their correlations were low (only +0.529) and the mean values for a set of words common to the two sets of norms were very low (see Toglia and Battig, 1978, Table 2).

These differences are due to differences in the instructions to subjects. Thus the two sets of meaningfulness ratings are not comparable, and so were kept seperate (min 192; max 922; mean 600; s.d. 107).

AOA

This is age of acquisition from the norms of Gilhooly and Logie (1980), multiplied by 100 to produce a range from 100 to 700 (min 125; max 697; mean 405; s.d. 120).

TQ2

When TQ2 has the value Q (40810 occurrences), this word is a derivational variant of another.

WTYPE

This is syntactic category as represented in the SOED database assembled by Dolby, Resnikoff and MacMurray (1963). There are ten different syntactic categories, coded as shown in Table 5.

TABLE 5
Syntactic Category Codes for WTYPE

| SYNTACTIC CATEGORY | CODE | OCCURRENCES |
|---|---|---|
| Noun | N | 77355 |
| Adjective | J | 25547 |
| Verb | V | 30725 |
| Adverb | A | 4243 |
| Preposition | R | 230 |
| Conjunction | C | 108 |
| Pronoun | U | 134 |
| Interjection | I | 352 |
| Past Participle | P | 5939 |
| Other | O | 6136 |

PDWTYPE

When you are interested in syntactic category, WTYPE can sometimes be unsatisfactory. For example, the words FREEZE and HARASS are Nouns according to WTYPE (as well as verbs); and indeed when these are looked up in SOED or Webster's, they are described as nouns. If you want to avoid such esoteric usages, PDWTYPE may be useful. It refers to the syntactic categories given in Jones' Pronouncing Dictionary (Jones, 1963), and very unusual uses of words are not considered. However PDWTYPE uses only four categories, not ten: these four are noun (N, 22061 occurrences), verb (V, 6333 occurrences), adjective (J, 8817 occurrences) and other (O, 1197 occurrences). The mapping from WTYPE to PDWTYPE is shown in Table 6.

TABLE 6
The Mapping from WTYPE to PDWTYPE

| OCCURRENCES | WTYPE | PDWTYPE |
|---|---|---|
| 3751 | A | |
| 492 | A | O |
| 47 | C | |
| 61 | C | O |
| 261 | I | |
| 91 | I | O |
| 16730 | J | |
| 8817 | J | J |
| 55294 | N | |
| 22061 | N | N |
| 5785 | O | |
| 351 | O | O |
| 5939 | P | |
| 115 | R | |
| 115 | R | O |
| 65 | U | |
| 69 | U | O |
| 24392 | V | |
| 6333 | V | V |

ALPHSYL

If this =A, then the word is an abbreviation (130 occurrences); if S, the word is a suffix (282 occurrences); if P, a prefix (1374 occurrences); if H, the word is hyphenated (13716 occurrences); if T, a multi-word phrasal unit (436 occurrences). For all of these categories, NSYL=0. For all other words ALPHYSL is blank.

STATUS

The 15 possible categories of STATUS are listed in Table 7; these are as given in the Dolby database (Dolby et al., 1963) derived from the Shorter Oxford English Dictionary, and perusal of Table 7 should make the meanings of these categories sufficiently clear.

TABLE 7
The Possible Values of STATUS

| STATUS OF | | |
|---|---|---|
| WORD | CODE | OCCURRENCES |
| Dialect | D | 2780 |
| Alien | F | 6003 |
| Archaic | A | 959 |
| Colloquial | Q | 405 |
| Capital | C | 2 |
| Erroneous | N | 0 |
| Nonsense | E | 62 |
| Nonce Word | W | 33 |
| Obsolete | O | 10549 |
| Poetical | P | 183 |
| Rare | R | 2756 |
| Rhetorical | H | 22 |
| Specialised | $ | 7731 |
| Standard | S | 58065 |
| Substandard | Z | 0 |

VAR

This refers to words which have the same spelling but different pronunciation and syntactic classes. When the pronunciations differ only in respect of stress (e.g. object, insult) VAR=0 (212 occurrences).When the pronunciations differ phonemically (e.g. moderate, abuse), VAR=B (1233 occurrences).

CAP

If this =C, then the word is normally written with an initial capital letter. This can be used as an indicator of proper nouns such as the names of people, towns, states and countries.

IRREG

This refers to the plurality of words. Where IRREG=Z, the word is plural (17441 occurrences), this can be used in conjunction with TQ2 to select irregular forms; where IRREG=Y, the word is a singular form (1024 occurrences); where IRREG=B, the word is both the singular and the plural form (151 occurrences); where IRREG=N, the word has no plural form (4407 occurrences); where IRREG=P, the word is plural but acts singular (88 occurrences)

WORD

The dictionary is ordered by the ascii sequence of these strings. Although there are 150837 entries in the dictionary, there are only 115331 different strings. The distribution of homographs is as follows:

| NUMBER OF ENTRIES | NUMBER OF WORDS |
|---|---|
| 1 | 94225 |
| 2 | 22132 |
| 3 | 2967 |
| 4 | 703 |
| 5 | 96 |
| 6 | 20 |
| 7 | 5 |

PHON and DPHON

The 12th edition of Daniel Jones's Pronouncing Dictionary (Jones, 1963) was transferred to magnetic tape by Professor L. Guierre (Guierre, 1966). These are used as the basis of the phonetic transcriptions in the PHON field. The phonetic symbols used on this tape were adjusted following suggestions from Roger Mitton (see Mitton, 1986), to conform to the U.K. Alvey standard for machine readable phonetic transcription (Wells, 1986). The changes in phonetic symbols used from Coltheart (1981a) made by y Quinlan (1986) include: devoiced consonants have been folded into their voiced equivalents; Coltheart (1981a) refers to the symbol 3, which has been ditched as no occurrence could be found; I(and U(have been mapped into I and U respectively. The symbols currently used in PHON field are a ‘/’ character to denote syllable boundaries and those presented in Table 8 with, where printable, the International Phonetic Alphabet equivalents. The DPHON field uses these symbols without the syllable distinguisher, but with the inclusion of the TQ2 symbols following the phonetic transcription. DPHON also includes the following three characters:−+R. The hyphen is used to represent the hyphen in hyphenated spellings. The ‘R’ character is used to represent a final R in the first part of hyphenated words which is only pronounced if the second part of a hyphenated word begins with a vowel. The ‘+’ sign is used to indicate the division between the two parts of a compound noun written without a space (indicated by ALPHSYL=T) or hyphenation (indicated by ALPHSYL=H).

TABLE 8
Phonetic Symbols used in the Dictionary

| CONSONANTS | | | VOWELS | | |
|---|---|---|---|---|---|
| IPA | | DATABASE | IPA | EX- | DATABASE |
| PHONETIC | EX- | PHONETIC | PHONETIC | AM- | PHONETIC |
| SYMBOL | AMPLE | SYMBOL | SYMBOL | PLE | SYMBOL |
| p | put | p | i: | bean | i |
| b | but | b | a: | barn | A |
| t | ten | t | : | born | O(oh) |
| d | den | d | u: | boon | u |
| k | can | k | v | burn | 3 |
| m | man | m | i | pit | I |
| n | not | n | S | pet | e |
| l | like | l | de | pat | & |
| r | run | r | \hat{ } | putt | V |
| f | full | f | o | pot | 0 (zero) |
| v | very | v | C | good | U |
| s | some | s | ] | about | @ |
| z | zeal | z | ei | bay | eI |
| h | hat | h | ai | buy | aI |
| w | went | w | i | boy | oI (oh) |
| g | game | g | oC | no | @U |
| t\hat{ } | chain | tS | aC | now | aU |
| dz | Jane | dZ | i] | peer | I@ |
| \ | long | 9 | S] | pair | e@ |
| O | thin | T | C] | poor | u@ |
| I | then | D | | | |
| \hat{ } | ship | S | | | |
| Q | measure | z | | | |
| j | yes | j | | | |

References

Amsler, R. A. (1984). Machine-Readable Dictionaries. In M. E. Williams (Ed.), Annual Review of Information Science and Technology (ARIST), 19, 161-209. American Society for Information Science (ASIS); Knowledge Industry Publications, Inc.

Brown, G. D. A. (1984). A frequency count of 190,000 words in the London-Lund Corpus of English Conversation. Behavioural Research Methods Instrumentation and Computers, 16 (6), 502-532.

Coltheart, M. (1981a). MRC Psycholinguistic Database User Manual: Version 1. [This is a now hard-to-find “in house” production. Mike Wilson has kindly provided an OCR transcript online.]

Coltheart, M. (1981b). The MRC Psycholinguistic Database. Quarterly Journal of Experimental Psychology, 33A, 497-505.

Dolby, J. L, Resnikoff, H. L. and MacMurray, F. L. (1963). A tape dictionary for linguistic experiments. In Proceedings of the American Federation of information processing societies: Fall Joint Computer Conference, Volume 24. Baltimore, Md.: Spartan Books. 419-23.

Gilhooly, K. J. and Logie, R. H. (1980). Age of acquisition, imagery, concreteness, familiarity and ambiguity measures for 1944 words. Behaviour Research Methods and Instrumentation, 12, 395-427.

Guierre, L. (1966). Un codage des mots anglais en vue de l'analyse automatique de leur structure phonetique. Etudes de linguistique appliquee, 4, 48-64.

Kiss, G. R., Armstrong, C., Milroy, R. and Piper, J (1973). An associative thesaurus of English and its computer analysis. In Aitkin, A. J., Bailey, R. W., and Hamilton-Smith, N. (Eds.), The computer and Literary Studies. Edinburgh: University Press.

Kucera and Francis, W. N. (1967). Computational Analysis of Present-Day American English. Providence: Brown University Press.

Mitton, R. (1986). A description of the files CUVOALD.DAT and CUV2.DAT The machine usable form of the Oxford Advanced Learner's Dictionary. The Oxford Text Archive: Oxford, U.K.

Pavio, A., Yuille, J. C. and Madigan, S. A. (1968). Concreteness, imagery and meaningfulness values for 925 words. Journal of Experimental Psychology Monograph Supplement, 76 (3, part 2).

Quinlan, P. (1986). Description of machine-readable dictionary files. Report. Dept. of Psychology, Birkbeck College, London.

Svartik, J. and Quirk, R. (1980). A Corpus of English Conversation. Lund: Gleerup.

Thorndike, E. L. and Lorge, I. (1944). The Teacher's Word Book of 30,000 Words. New York: Teachers College, Columbia University.

Toglia, M. P. and Battig, W. R. (1978). Handbook of Semantic Word Norms. New York: Erlbaum.

Wells, J. W. (1986). A standardised machine-readable phonetic notation. In Proceedings of the IEE conference on speech input/output: techniques and applications. London, Easter 1986.

Contents of file mrcs2.doc (distributed with MRC Psycholinguistic Database) Edited/Hyperized Mar. 6, 1997, Craig Clark, UWA Psychology

Web Manager/mrc2.html/web@psy.uwa.edu.au

What is claimed is:

1. A method of conveying electronic information content to a consumer using a rapid serial presentation technique, the content characterized by a sequence of terms, the method comprising:
maintaining a plurality of rule sets, each of the rule sets defining rules for generating targets and descriptors for a rapid serial presentation of the terms based at least in part on attributes of the terms, each rule set customized for at least one of a particular consumer and a particular type of content;
selecting a rule set, from among the plurality of rule sets, based on at least one of a consumer specification and the type of content;
accessing a dictionary to obtain quantified attributes associated with at least some of the terms; and
generating a sequence of targets and corresponding descriptors for the rapid serial presentation of the terms using the selected rule set and the quantified attributes obtained from the dictionary, the descriptors defining characteristics for outputting the targets during a rendering of the rapid serial presentation.

2. A method according to claim 1, wherein each target comprises at least one of:
a single term;
a group of terms;
an audio component;
a video component;
an image component; and
a tactile component.

3. A method according to claim 1, wherein selecting the rule set based on the type of content comprises:
determining the type of content based at least one of a search term provided by the consumer and an analysis of the content; and
selecting the rule set based on the determined type of content.

4. A method according to claim 1, wherein selecting the rule set based on a consumer selection comprises at least one of:
selecting the rule set based on a consumer profile; and
receiving an input from the consumer identifying the selected rule set.

5. A method according to claim 1, wherein the attributes obtained from the dictionary include psycholinguistic attributes for at least some of the terms.

6. A method according to claim 1, further comprising:
selecting the dictionary from among a plurality of dictionaries based on at least one of a consumer selection and the type of content, wherein each of the dictionaries is customized for at least one of a particular consumer and a particular type of content.

7. A method according to claim 6, wherein selecting the dictionary based on the type of content comprises:
determining the type of content based at least one of a search term provided by the consumer and an analysis of the content; and
selecting the dictionary based on the determined type of content.

8. A method according to claim 6, wherein selecting the dictionary based on a consumer selection comprises at least one of:
selecting the dictionary based on a consumer profile; and
receiving an input from the consumer identifying the selected dictionary.

9. A method according to claim 1, wherein generating the sequence of targets and corresponding descriptors further comprises:
analyzing the content for at least one of syntax and semantics; and
generating the sequence of targets and corresponding descriptors based at least in part on such analysis.

10. A method according to claim 1, wherein generating the sequence of targets and corresponding descriptors further comprises:
generating the sequence of targets and corresponding descriptors based at least in part on a consumer profile, the consumer profile including at least one of preference information provided by the consumer and feedback information characterizing consumer experience with rapid serial presentations.

11. A method according to claim 10, wherein the feedback information comprises at least one of:
information relating to a latent physiological condition of the consumer monitored during rendering of the rapid serial presentation; and
information relating to consumer inputs during rendering of the rapid serial presentation.

12. A method according to claim 1, further comprising:
providing an authoring tool enabling a user to modify the sequence of targets and corresponding descriptors, such modification including at least one of:
converting multiple targets into a single target;
converting a single target into multiple separate targets;
defining characteristics for outputting a target;
inserting an additional target; and
removing a target.

13. A method according to claim 1, further comprising:
including at the beginning of the rapid serial presentation a number of advertisements, the number of advertisements selected according to a price to be charged to the consumer for the rapid serial presentation.

14. A method according to claim 1, wherein generating the targets and corresponding descriptors comprises:
determining the order in which different portions of content are to be delivered to the consumer based on a context for the rapid serial presentation; and
generating the targets and corresponding descriptors based at least in part on the determined order and the context.

15. A method of conveying electronic information content to a consumer using a rapid serial presentation technique, the content characterized by a sequence of terms, the method comprising:
accessing a dictionary to obtain psycholinguistic attributes associated with at least some of the terms; and
generating a sequence of targets and corresponding descriptors for a rapid serial presentation of the terms using the associated psycholinguistic attributes, the descriptors defining characteristics for outputting the targets during a rendering of the rapid serial presentation.

16. A method according to claim 15, further comprising:
selecting the dictionary from among a plurality of dictionaries based on at least one of a consumer selection and the type of content, wherein each of the dictionaries is customized for at least one of a particular consumer and a particular type of content.

17. A method according to claim 16, wherein selecting the dictionary based on the type of content comprises:
determining the type of content based at least one of a search term provided by the consumer and an analysis of the content; and
selecting the dictionary based on the determined type of content.

18. A method according to claim 16, wherein selecting the dictionary based on a consumer selection comprises at least one of:
selecting the dictionary based on a consumer profile; and
receiving an input from the consumer identifying the selected dictionary.

19. A method of conveying electronic information content to a consumer using a rapid serial presentation technique, the content characterized by a sequence of terms, the method comprising:
maintaining a plurality of rule sets, each of the rule sets defining rules for generating targets and descriptors for a rapid serial presentation of the terms, each rule set customized for at least one of a particular consumer and a particular type of content;
selecting a rule set, from among the plurality of rule sets, based on at least one of a consumer specification and the type of content; and
generating a sequence of targets and corresponding descriptors for the rapid serial presentation of the terms using the selected rule set, the descriptors defining characteristics for outputting the targets during a rendering of the rapid serial presentation.

20. A method according to claim 19, wherein selecting the rule set based on the type of content comprises:
determining the type of content based at least one of a search term provided by the consumer and an analysis of the content; and
selecting the rule set based on the determined type of content.

21. A method according to claim 19, wherein selecting the rule set based on a consumer selection comprises at least one of:
selecting the rule set based on a consumer profile; and
receiving an input from the consumer identifying the selected rule set.

22. Apparatus for generating a rapid serial presentation of electronic information content, the content characterized by a sequence of terms, the apparatus comprising:
a network interface for enabling communication over a communications network;
a database for storing a plurality of rule sets, each of the rule sets defining rules for generating targets and descriptors for a rapid serial presentation of the terms based at least in part on attributes of the terms, each rule set customized for at least one of a particular consumer and a particular type of content; and
a presentation generator, in communication with the database and with the network interface, for generating the rapid serial presentation, the presentation generator configured to select a rule set, from among the plurality of rule sets, based on at least one of a consumer specification and the type of content; access a dictionary to obtain quantified attributes associated with at least some of the terms; and generate a sequence of targets and corresponding descriptors for the rapid serial presentation of the terms using the selected rule set and the quantified attributes obtained from the dictionary, the descriptors defining characteristics for outputting the targets during a rendering of the rapid serial presentation.

23. Apparatus according to claim 22, wherein the dictionary is stored in the database.

24. Apparatus according to claim 22, wherein the dictionary is accessed over the communications network via the network interface.

25. Apparatus according to claim 22, wherein each target comprises at least one of:
a single term;
a group of terms;
an audio component;
a video component;
an image component; and
a tactile component.

26. Apparatus according to claim 22, wherein the attributes obtained from the dictionary include psycholinguistic attributes for at least some of the terms.

27. Apparatus according to claim 22, wherein the presentation generator is configured to select the dictionary from among a plurality of dictionaries based on at least one of a consumer selection and the type of content, wherein each of the dictionaries is customized for at least one of a particular consumer and a particular type of content.

28. Apparatus according to claim 22, wherein the presentation generator is configured to analyze the content for at least one of syntax and semantics and to generate the sequence of targets and corresponding descriptors based at least in part on such analysis.

29. Apparatus according to claim 22, wherein the presentation generator is configured to generate the sequence of targets and corresponding descriptors based at least in part on a consumer profile, the consumer profile including at least one of preference information provided by the consumer and feedback information characterizing consumer experience with rapid serial presentations.

30. Apparatus according to claim 29, wherein the consumer profile is stored in the database.

31. Apparatus according to claim 22, further comprising:
a web server, in communication with the database, the network interface, and the presentation generator, for at least one of obtaining content via the network interface, transmitting the rapid serial presentation to a consumer device via the network interface, and configuring the presentation generator.

32. Apparatus according to claim 22, further comprising:
an authoring tool for enabling a user to modify the sequence of targets and corresponding descriptors, such modification including at least one of:
converting multiple targets into a single target;
converting a single target into multiple separate targets;
defining characteristics for outputting a target;
inserting an additional target; and
removing a target.

33. A method of rendering a rapid serial presentation to a consumer, the rapid serial presentation including a sequence of targets and corresponding descriptors, the method comprising:
outputting targets on a consumer device in accordance with the corresponding descriptors;
concurrently with such outputting, monitoring a latent physiological condition of the consumer;
analyzing the latent physiological condition to infer an emotional state of the consumer with regard to the rapid serial presentation; and
dynamically adjusting the outputting of subsequent targets based on the inferred emotional state of the consumer.

34. A method according to claim 33, wherein the latent physiological condition includes at least one of:
heart rate;
blood flow;
brain waves;
electronic signals;
galvanic skin response;
breathing, and
temperature.

35. A method according to claim 33, further comprising:
transmitting feedback information relating to the latent physiological condition to a presentation server for use in generating a subsequent rapid serial presentation for the consumer.

36. Apparatus for rendering a rapid serial presentation to a consumer, the rapid serial presentation including a sequence of targets and corresponding descriptors, the apparatus comprising:
a network interface for enabling communication over a communications network and over which the rapid serial presentation is received;
at least one output;
a physiological sensor; and
a presentation player, in communication with the network interface, the at least one output, and the physiological sensor, the presentation player configured to output targets using the at least one output in accordance with the corresponding descriptors; concurrently monitor a latent physiological condition of the consumer using the physiological sensor; analyze the latent physiological condition to infer an emotional state of the consumer with regard to the rapid serial presentation; and dynamically adjust the outputting of subsequent targets based on the inferred emotional state of the consumer.

37. Apparatus according to claim 36, wherein the at least one output comprises at least one of:
a display screen;
an audio output; and
a tactile output.

38. Apparatus according to claim 36, wherein the latent physiological condition includes at least one of:
heart rate;
blood flow;
brain waves;
electronic signals;
galvanic skin response; and
breathing.

39. Apparatus according to claim 36, wherein the presentation player is configured to transmit via the network interface feedback information relating to the latent physiological condition to a presentation server for use in generating a subsequent rapid serial presentation for the consumer.

40. Apparatus according to claim 36, further comprising:
a web browser, in communication with the network interface and the presentation player.

41. Apparatus according to claim 40, wherein the presentation player is integrated with the web browser.

42. Apparatus according to claim 36, further comprising:
at least one input, in communication with the presentation player, through which the consumer can manually control various aspects of the outputting of the targets.

43. A rapid serial presentation system comprising:
a server for generating a rapid serial presentation for a consumer; and
a consumer device, in communication with the server, for rendering the rapid serial presentation to the consumer, wherein the consumer device is configured to transmit feedback information to the server, the feedback information characterizing the consumer experience with the rapid serial presentation, and wherein the server is configured to use the feedback information in generating a subsequent rapid serial presentation for the consumer.

44. A system according to claim 43, wherein the feedback information comprises at least one of:
information relating to a latent physiological condition of the consumer monitored during rendering of the rapid serial presentation; and
information relating to consumer inputs during rendering of the rapid serial presentation.

45. A method of presenting electronic information content to a consumer using a rapid serial presentation technique, the method comprising:
recording a reading of the content;
analyzing the recorded reading to identify verbal characteristics;
parsing the content into a sequence of terms; and
generate a sequence of targets and corresponding descriptors using the verbal characteristics, so that a rapid serial visual presentation of the targets will mimic at least in part the verbal characteristics.
